(19) United States
(12) Patent Application Publication
(10) Pub. No.: US 2009/0072782 A1
(43) Pub. Date: Mar. 19, 2009

(54) VERSATILE APPARATUS AND METHOD FOR ELECTRONIC DEVICES

(76) Inventor: Mitch Randall, Longmont, CO (US)

Correspondence Address: COCHRAN FREUND & YOUNG LLC, 2026 CARIBOU DR, SUITE 201, FORT COLLINS, CO, 80525, US

(21) Appl. No.: 11/682,309

(22) Filed: Mar. 5, 2007

Related U.S. Application Data
(63) Continuation-in-part of application No. 11/672,010, filed on Feb. 6, 2007.
Application No. 11/672,010 is a continuation-in-part of application No. 11/670,842, filed on Feb. 2, 2007.
(60) Provisional application No. 60/778,761, filed on Mar. 3, 2006.
(60) Provisional application No. 60/781,456, filed on Mar. 10, 2006.
(60) Provisional application No. 60/797,140, filed on May 3, 2006.
(60) Provisional application No. 60/444,826, filed on Feb. 4, 2003.
(60) Provisional application No. 60/441,794, filed on Jan. 22, 2003.
(60) Provisional application No. 60/432,072, filed on Dec. 10, 2002.
(60) Provisional application No. 60/776,332, filed on Feb. 24, 2006.

(51) Int. Cl. H02J 7/00; H05K 7/14; H02J 17/00

(52) U.S. Cl. 320/107; 307/149; 307/104; 320/137

(57) ABSTRACT

An electronic system which includes a power delivery surface that delivers electrical power to an electrical or electronic device. The power delivery surface may be powered by any electrical power source, including, but not limited to: wall electrical outlet, solar power system, battery, vehicle cigarette lighter system, direct connection to electrical generator device, and any other electrical power source. The power delivery surface delivers power to the electronic device wirelessly. The power delivery surface may deliver power via a plurality of contacts on the electrical device conducting electricity from the power delivery surface, conductively coupling the electronic device to the power delivery surface, inductively coupling the electronic device to the power delivery surface, optically coupling the electronic device to the power delivery surface, and acoustically coupling the electronic device to the power delivery surface as well as any other electrical power delivery mechanism.

### CROSS-REFERENCES TO RELATED APPLICATIONS

This application claims the benefit of U.S. Provisional Application No. 60/778,761, filed Mar. 3, 2007, U.S. Provisional Application No. 60/781,456, filed Mar. 10, 2007, and U.S. Provisional Application No. 60/797,140, filed May 3, 2006, all of which are incorporated herein by reference, and it is a continuation-in-part of U.S. patent application Ser. No. 11/670,842, filed Feb. 2, 2007, and U.S. patent application Ser. No. 11/672,010, filed on Feb. 6, 2007, which additionally claims the benefit of U.S. Provisional Application No. 60/776,332, filed Feb. 24, 2006, which are a divisional patent application and a continuation-in-part patent application, respectively, from U.S. patent application Ser. No. 10/732,103, filed on Dec. 10, 2003, which claims the benefit of U.S. Provisional Application Nos. 60/432,072, filed Dec. 10, 2002, U.S. Provisional Application No. 60/441,794, filed Jan. 22, 2003, and U.S. Provisional No. 60/444,826, filed Feb. 4, 2003, all of which are also incorporated herein by reference

### BACKGROUND OF THE INVENTION

1. Field of the Invention

The present invention relates to electronic systems and methods for providing electrical power to one or more electronic devices with a power delivery surface.

2. Description of the Related Art

A variety of electronic devices, such as toys, game devices, cell phones, laptop computers, cameras and personal digital assistants, have been developed along with ways for powering them. Mobile electronic devices typically include a battery which is rechargeable by connecting it through a power cord unit to a power source, such as an electrical outlet. A non-mobile electronic device is generally one that is powered through a power cord unit and is not intended to be moved during use.

In a typical set-up for a mobile device, the power cord unit includes an outlet connector for connecting it to the power source and a battery connector for connecting it to a corresponding battery power receptacle of the battery. The outlet and battery connectors are in communication with each other so electrical signals flow between them. In this way, the power source charges the battery through the power cord unit.

In some setups, the power cord unit also includes a power adapter connected to the outlet and battery connectors through AC input and DC output cords, respectively. The power adapter adapts an AC input signal received from the power source through the outlet connector and AC input cord and outputs a DC output signal to the DC output cord. The DC output signal flows through the battery power receptacle and is used to charge the battery.

Manufacturers, however, generally make their own model of electronic device and do not make their power cord unit compatible with the electronic devices of other manufacturers, or with other types of electronic devices. As a result, a battery connector made by one manufacturer will typically not fit into the battery power receptacle made by another manufacturer. Further, a battery connector made for one type of device typically will not fit into the battery power receptacle made for another type of device. Manufacturers do this for several reasons, such as cost, liability concerns, different power requirements, and to acquire a larger market share.

This may be troublesome for the consumer because he or she has to buy a compatible power cord unit for their particular electronic device. Since people tend to switch devices often, it is inconvenient and expensive for them to also have to switch power cord units. Further, power cord units that are no longer useful are often discarded which leads to waste. Also, people generally own a number of different types of electronic devices and owning a power cord unit for each one is inconvenient because the consumer must deal with a large quantity of power cord units and the tangle of power cords the situation creates.

### BRIEF SUMMARY OF THE INVENTION

An embodiment employs an electronic system which includes a power delivery surface that delivers electrical power to an electrical or electronic device. The power delivery surface may be powered by any electrical power source, including, but not limited to: wall electrical outlet, solar power system, battery, vehicle cigarette lighter system, direct connection to electrical generator device, and any other electrical power source. The power delivery surface delivers power to the electronic device wirelessly. The power delivery surface may deliver power via a plurality of contacts on the electrical device conducting electricity from the power delivery surface, conductively coupling the electronic device to the power delivery surface, inductively coupling the electronic device to the power delivery surface, optically coupling the electronic device to the power delivery surface, and acoustically coupling the electronic device to the power delivery surface as well as any other electrical power delivery technology.

One embodiment may include a device comprising a battery having a plurality of contacts connected thereto. The contacts are arranged so that when the battery is carried by a power delivery support structure, at least two contacts in the plurality of contacts have a potential difference between them which charges the battery. For various embodiments, the battery may include a power adapter circuit. The power adapter circuit receives the potential difference and outputs a desired potential difference which is used to charge the battery. For some embodiments, the system may also include a battery charger having a housing that defines a battery compartment and carries a pair of charger contacts therein. The battery compartment is sized and shaped to receive the battery.

These and other features, aspects, and advantages of the invention will become better understood with reference to the following drawings, description, and claims.

### BRIEF DESCRIPTION OF THE DRAWINGS

FIG. 1 is a perspective view of a power delivery system, in accordance with the invention, which includes a power delivery support structure operatively coupled with an electronic device.

FIG. 2a is a partial side view of the electronic device of FIG. 1, which includes a power adapter circuit.

FIG. 2b is a side view of the power delivery system of FIG. 1, operatively coupled with a magnetic element of the electronic device.

FIG. 2c is a side view of the power delivery system of FIG. 1, operatively coupled with contacts of the electronic device.

FIG. 3 is a top view of the power delivery system of FIG. 1 operatively coupled with different types of electronic devices.

FIG. 4a is a block diagram of the power adapter circuit of FIG. 2a, in accordance with the invention.

FIG. 4b is a schematic diagram of one embodiment of a rectifier circuit included in the power adapter circuit of FIG. 2a.

FIGS. 5a, 5b, and 5c are perspective views of various ways to provide power to power delivery systems, in accordance with the invention.

FIGS. 6a, 6b, and 6c are top views of a solar power delivery system with a power delivery system, in accordance with the invention, in deployed, partially deployed, and stowed positions, respectively.

FIG. 7 is a block diagram showing the different types of electronic devices that can be operatively coupled with a power delivery support structure, in accordance with the invention.

FIG. 8 is a perspective view of a power delivery support structure and an electronic device embodied as a laptop computer, in accordance with the invention.

FIGS. 9a and 9b are perspective views of an electronic device, embodied as a laptop computer, with a power connector, in accordance with the invention.

FIGS. 9c and 9d are side and top views, respectively, of the power connector of FIGS. 9a and 9b.

FIG. 10a is a perspective view of a power delivery system, in accordance with the invention, having a power connector operatively coupled with a power delivery support structure.

FIG. 10b shows a more detailed perspective view of the power connector of FIG. 10a when it is not operatively coupled with the power delivery support structure.

FIG. 10c is a cut-away side view of the power connector of FIG. 10a.

FIG. 10d is a perspective view of a power delivery system, in accordance with the invention, with a power connector connected to a power source through a power cord unit.

FIGS. 11a and 11b are top and bottom perspective views of a battery charger, in accordance with the invention.

FIGS. 11c and 11d are top and bottom perspective views of an electronic device, embodied as a battery, in accordance with the invention, for use with the battery charger of FIGS. 11a and 11b.

FIGS. 11e and 11f are top and bottom perspective views, respectively, of the battery of FIGS. 9c and 9d with its casing partially unfolded.

FIGS. 12a and 12b are top and bottom perspective views of an electronic device, in accordance with the invention, embodied as a battery charger.

FIGS. 13a and 13b are top and bottom perspective views of an electronic device, in accordance with the invention, embodied as a battery charger.

FIG. 14 is a perspective view of a power delivery support structure, in accordance with the invention, with a power delivery structure in an upright position.

FIG. 15 is a perspective view of a power tool and a power adapter, in accordance with the invention.

FIG. 16a is a perspective view of a power delivery system, in accordance with the invention, having a power delivery support structure and an electronic device embodied as a cup carried by a cup holder.

FIGS. 16b and 16c are sectional side views of the cup and cup holder of FIG. 12a taken along a cut line 12a-12a′ of FIG. 12a.

FIG. 17 is a block diagram showing the different places that a power delivery support structure, in accordance with the invention, can be used.

FIGS. 18a and 18b are perspective views of electronic devices, in accordance with the invention, embodied as a scanner and printer, respectively, having a power delivery support structure.

FIGS. 19a and 19b are perspective views of an electronic device, in accordance with the invention, embodied as a laptop computer having a power delivery support structure.

FIG. 20 is a perspective view of an electronic device, in accordance with the invention, embodied as a laptop computer having a tray which carries a power delivery support structure, in accordance with the invention.

FIGS. 21a and 21b are perspective views of an electronic device, in accordance with the invention, embodied as a laptop computer having a tray which carries a power delivery support structure, in accordance with the invention.

FIG. 22 is a perspective view of an electronic device, embodied as a laptop computer, connected to a power delivery support structure, in accordance with the invention, through a power cord unit.

FIGS. 23a, 23b and 23c are perspective views of furniture, embodied as a couch, table and desk, respectively, having a power delivery support structure, in accordance with the invention.

FIGS. 24a, 24b, 24c and 24d are perspective views of appliances, embodied as a digital clock, microwave oven, refrigerator and tool box, respectively, each including a power delivery support structure, in accordance with the invention.

FIG. 25a is a perspective view of the interior of a motor vehicle, embodied as car, having a power delivery support structure, in accordance with the invention.

FIG. 25b is a perspective view of a vehicle, embodied as an airplane, which includes airplane seating having a power delivery support structure, in accordance with the invention.

FIG. 26 is a perspective view of a stowaway power delivery surface.

FIG. 27 is a perspective view of a rolled-up power delivery surface.

FIGS. 28a, 28b, and 28c are perspective views of folded power delivery surfaces.

FIGS. 29a and 29b show perspective views of interlocking mechanisms to attach adjacent power delivery surfaces.

FIG. 29c shows a schematic view of the placement of multiple interconnecting power delivery surfaces with the appropriate sides marked for proper mechanical attachment.

FIG. 29d shows a schematic view of the placement of multiple interconnecting power delivery surfaces with the appropriate corners marked for proper electrical attachment.

FIG. 29e shows a perspective view of the electrical attachment at the corner of multiple attached power delivery surfaces.

FIG. 30 is a block diagram of a circuit within the power connector described with respect to FIGS. 10a, 10b, 10c, and 10d.

FIGS. 31a, 31b, 31c, 31d, 31e, and 31f are perspective drawings of apparatuses providing functional and aesthetic illumination for a power delivery surface.

FIG. 32a is a schematic drawing of a power delivery surface broken down into several independent sections.

FIGS. 32b and 32c are schematic block diagrams of power delivery and protection circuits for a power delivery surface broken down into several independent sections.

FIG. 33a is a schematic block diagram of a device that has a battery with an integrated power receiver.

FIGS. 33b and 33c are perspective drawings of a battery and a host device.

FIG. 33d is a schematic block diagram of a device that has a battery with an integrated power receiver and regulator.

FIG. 33e is a schematic block diagram of a device that has a battery with an integrated power receiver, regulator, and charging regulator.

FIG. 33f is a schematic block diagram of a device that has a fully integrated battery.

FIG. 34 is a block diagram of a device equipped with a power receiver, optional regulator, and sensing circuitry.

FIG. 35 is a schematic diagram of a circuit to sense the shut down of the power delivery surface.

FIG. 36 is a block diagram of universal device interface formed by integrating a power converter (regulator) between the power receiver and the device's power input.

FIG. 37 is a schematic of the regulator circuit between the power receiver and the device's power input.

FIG. 38 is a schematic diagram of a bridge rectifier circuit used to detect a linear load.

FIG. 39 is a schematic diagram of the equivalent load connected to the circuit of FIG. 38.

FIGS. 40a, 40b, and 40c are Voltage/Current (V/I) characteristic graphs for the circuit of FIG. 38 under various conditions.

FIG. 41 is a voltage versus time graph when applying switched DC to the circuit of FIG. 38.

FIG. 42 is a conceptual circuit of the switched DC application of FIG. 41.

FIG. 43 is a desired circuit for responding to the switched DC application of FIG. 41.

FIG. 44 is a plot of the voltage versus time graph to locate zero crossings when an AC current is applied.

FIG. 45 is block diagram of a circuit consistent with the graph of FIG. 44.

FIG. 46 is circuit schematic of a circuit consistent with the block diagram of FIG. 45.

FIG. 47 is a block diagram of an overpower detection and shutdown system.

FIG. 48 is a circuit block diagram of an electronic switch for a conductive solution to the overpower detection and shutdown system.

FIG. 49 is a circuit schematic of an embodiment of the block diagram of FIG. 48.

FIG. 50 is block diagram of an overpower detection and shutdown system with automatic retry.

FIG. 51 is circuit block diagram of an embodiment of the block diagram of FIG. 50 for a direct conduction system.

FIG. 52 is a block diagram of an under power detection and shutdown system.

FIG. 53 is a circuit schematic of an embodiment of the block diagram of FIG. 52.

FIG. 54 is a circuit diagram of an over voltage detection system.

FIG. 55 is a circuit diagram of a desired load detection system.

FIGS. 56a and 56b are circuit diagrams for certain desired loads.

FIG. 57 is a circuit block diagram for a combination detection and shutdown with automatic retry system.

FIG. 58 is circuit diagram for another embodiment of a combination detection and shutdown with automatic retry system.

FIG. 59 is a block diagram of a system for the power delivery surface to send data to an electronic device.

FIG. 60 is a circuit diagram of a power receiver detector circuit.

FIG. 61 is a diagram of the data transfer described in FIG. 59.

### DETAILED DESCRIPTION OF THE INVENTION

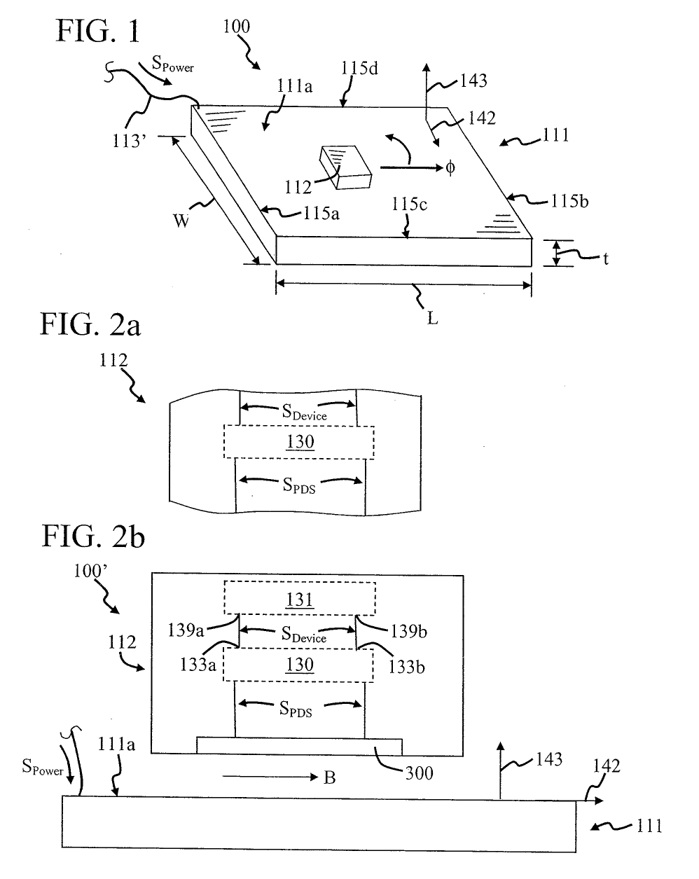

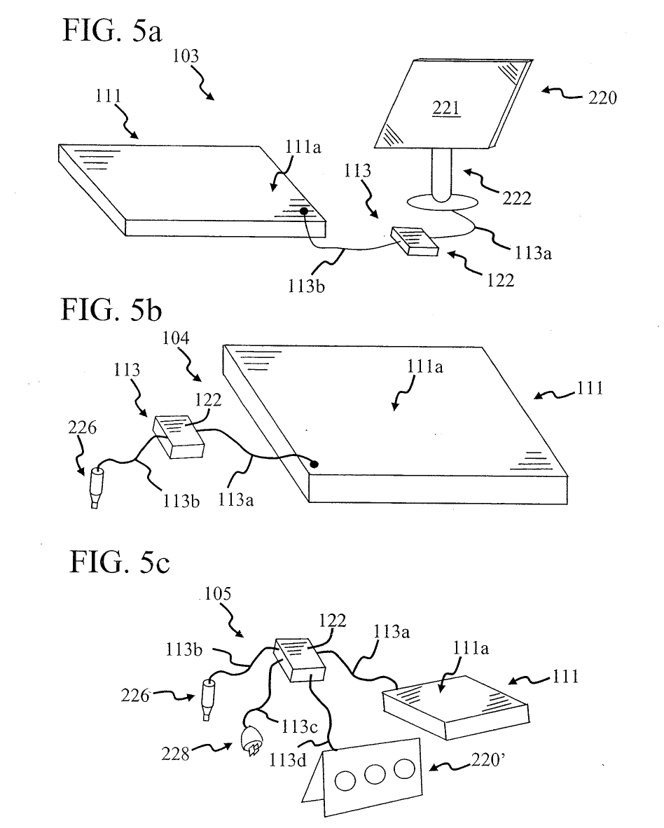

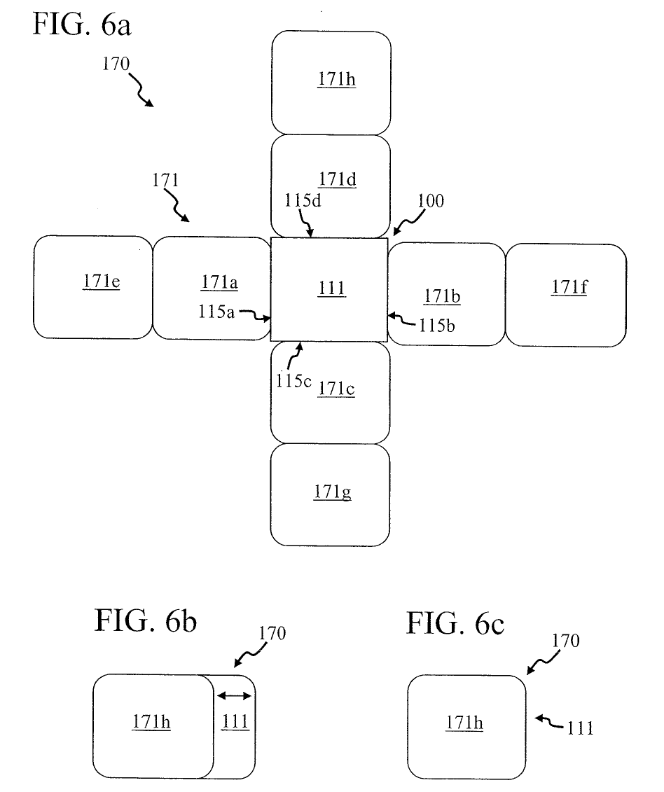

FIG. 1 is a perspective view of a power delivery system 100, in accordance with the invention. System 100 has many different embodiments that provide the features discussed herein and others. Several embodiments are discussed in co-pending U.S. patent application Ser. No. 11/670,842 filed on Feb. 2, 2007 and co-pending U.S. patent application Ser. No. 11/672,010 filed Feb. 6, 2007. In FIG. 1, system 100 includes a power delivery support structure 111 having a power delivery surface 111a which is used to provide power to an electronic device 112. Support structure 111 is connected through a power cord unit 113′ to a power source (not shown) which provides a power signal S_{Power} to it The power source can be of many different types, such as an electrical outlet, battery, vehicle cigarette lighter system, direct connection to an electrical generator device, and solar power system, some of which are discussed in more detail below with FIGS. 5a-5c and 6a-6c. Power delivery surface 111a can have many different shapes, but here it is rectangular with a width W, length L and thickness t, so structure 111 defines a rectangular volume. Surface 111a is also shown as being substantially flat, although it can be curved in other examples. In this embodiment, surface 111a extends between opposed sides 115a and 115b, as well as between opposed sides 115c and 115d. Opposed sides 115c and 115d extend from opposite ends of sides 115a and 115b and between them. Sides 115a and 115b are oriented at non-zero angles relative to sides 115c and 115d. In this particular embodiment, the non-zero angle is about 90° since surface 111a is rectangular. In other examples, surface 111a can have other shapes, such as round, triangular, etc. When surface 111a is round, structure 111 defines a cylindrical volume. The power delivery surface delivers power to devices 112 without wires, is capable of delivering power to multiple devices 112 of differing power requirements simultaneously, and permits devices 112 to receive power at any position and orientation on the power deliver surface 111a. The power delivery surface 111a may deliver wireless power to any device 112 whether mobile, not mobile, battery powered, or not battery powered.

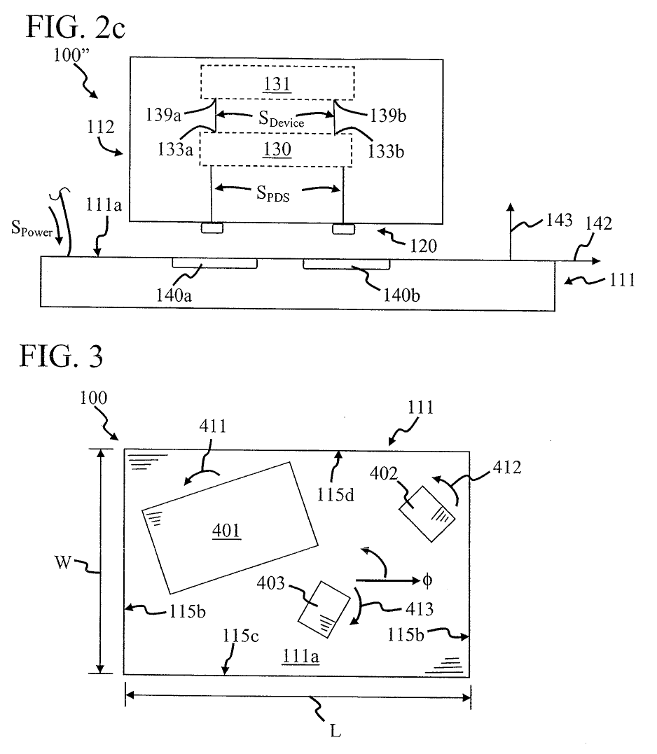

FIG. 2a is a partial side view of electronic device 112. In accordance with the invention, device 112 includes and carries a power adapter circuit 130. As discussed in more detail below, a power delivery signal S_{PDS} is provided to circuit 130, when signal S_{Power} is provided to structure 111, in response to device 112 being operatively coupled to power delivery support structure 111. It should be noted that the power in signal S_{PDS} is from the power in signal S_{Power}. When device 112 is operatively coupled to support structure 111, circuit 130 receives signal S_{PDS} and adapts it to a desired power signal, denoted as signal S_{Device}. Signal S_{Device} corresponds to a desired amount of power that is compatible with device 112 and is used to operate it. As discussed in more detail below, the desired amount of power depends on many different factors, such as the type of electronic device and the manufacturer. In this way, electronic device 112 is powered by support structure 111.

FIG. 2b is a side view of a power delivery system 100′, wherein signal S_{PDS} is provided to circuit 130 by magnetically coupling device 112 to power delivery structure 111. In this embodiment, electronic device 112 includes and carries a magnetic element 300, which is in communication with power adapter circuit 130. Element 300 can be of many different types, but it is an inductor in this example. Magnetic element 300 provides a magnetically induced current flow in response to being coupled with a changing magnetic field B. Changing magnetic field B is provided by support structure 111 through power delivery surface 111a in response to signal S_{Power}. In the embodiment shown, the magnetic field B expands and contracts such that the loops of electrical conductors in the inductor element 300 induce an electric current due to the changing magnetic field B. The magnetically induced current flow is provided by element 300 to power adapter circuit 130 as signal S_{PDS}. In this way, electronic device 112 and power delivery support structure 111 are operatively coupled together through a magnetic element and surface 111a operates as a power delivery surface wherein the power is provided with a changing magnetic field. It should be noted that electronic device 112 and power delivery support structure 111 can be operatively coupled together in many other ways, with one being discussed with FIG. 2c.

It should also be noted that magnetic field B can have many different orientations and is shown as being parallel to surface 111a for simplicity. The desired orientation of magnetic field B generally depends on the orientation of element 300. Further, the magnetically induced current may flow through magnetic element 300 when device 112 is engaged with power delivery support structure 111 or when it is away from it, as shown FIG. 2b. Generally the changing magnetic field of the power delivery surface would be generated by electricity passing through loops of conductive material that are part of the power support structure 111. The magnetic field would typically be perpendicular to the loop, thus, if the loop was parallel to the surface 111, the magnetic field would be perpendicular to the surface 111.

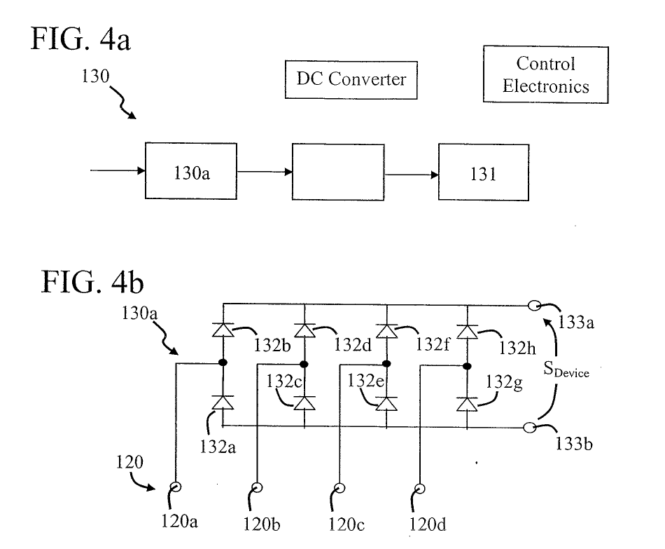

In this embodiment, adapter circuit 130 outputs signal S_{Device} to a power system 131 included in device 112. Power system 131 may be a rechargeable battery or other storage element, or power system 131 may be the power conditioning circuitry of a device 112. Circuit 130 includes contacts 133a and 133b which are connected to contacts 139a and 139b, respectively, of power system 131 so signal S_{Device} can flow between them. Power system 131 provides power to the electronics included in device 112, such as its display and control circuitry. These electronics are discussed further with FIG. 4a and are not shown here for simplicity.

Electronic device 112 can be powered in many different ways by power delivery support structure 111. For example, in some situations, signal S_{Device} provides charge to a battery included in power system 131, which is often the case for mobile devices. However, in other situations, signal S_{Device} powers the electronics in device 112 directly. One example of directly powering a device is a laptop computer, which may be operated if power is provided to it by support structure 111 after its battery has been removed. A direct connection may also be advantageous for various reasons such as that the device circuitry may recognize the application of power and indicate it on a display, or in some cases, the device may have built in charging circuitry or other features that would be advantageous to energize directly. For example, a cell phone may contain on-board charging circuitry and a display icon that indicates to the user the state of the battery and the status of charging that would be powered by a direct connection. In some cases it is desirable that signal S_{Device} is applied to the same input circuitry as the standard power adapter supplied by the manufacturer in order to reduce the complexity of the device's 112 input circuitry, or to provide the signal S_{Device} into the standard input connector of the device 112 thereby avoiding invasive modifications.

FIG. 2c is a side view of a power delivery system 100″, wherein signal S_{PDS} is provided to circuit 130 by electrically coupling device 112 to power delivery structure 111. In this embodiment, support structure 111 includes pads 140a and 140b which define a portion of power delivery surface 111a and electronic device 112 includes and carries contacts 120. Here, there are five contacts in contacts 120, but only two are shown for simplicity and are denoted as contacts 120a and 120b. It should be noted, however, that contacts 120 may include more or less than five contacts, but there are generally two or more contacts.

In operation, the power source flows signal S_{Power} to support structure 111 through power cord unit 113′ and a potential difference is provided between pads 140a and 140b in response. As discussed in more detail below, contacts 120 are arranged so that when device 112 is carried by structure 111, two contacts in contacts 120 have a potential difference between them because one engages pad 140a and the other engages pad 140b. In this example, contacts 120a and 120b engage pads 140a and 140b, respectively. In response, the potential difference between pads 140a and 140b is provided to power adapter circuit 130 through contacts 120a and 120b as signal S_{PDS}. Hence, signal S_{PDS} is provided to power adapter circuit 130 in response to device 112 being carried by support structure 111. Circuit 130 receives signal S_{PDS} and adapts it to correspond to the desired power signal S_{Device}, which is provided to system 131. In this way, electronic device 112 and power delivery support structure 111 are operatively coupled together through contacts.

It should be noted that the embodiments of electronic devices and power delivery support structures discussed below are operatively coupled together through contacts for illustrative purposes. However, these embodiments can be modified so the electronic devices and power delivery support structures are operatively coupled together through a magnetic induction element, as discussed with respect to FIG. 2b, or other forms of wireless power technologies such as a capacitive coupling element, an acoustic coupling element, light beam coupling element, etc.

In accordance with the invention, contacts 120 are arranged so signal S_{PDS} is provided to adapter circuit 130 independently of the orientation of device 112 relative to power delivery surface 111a. These contact arrangements are discussed in more detail in the above co-pending application. Briefly, signal S_{PDS} is provided to power adapter circuit 130 for all angles φ (FIG. 1a), wherein angle φ has values between about 0° and 360°. In this example, angle φ corresponds to the angle between a side (i.e. side 115a-115d) of structure 111 and a reference line 142 extending parallel to surface 111a and through device 112. It should be noted that the rotation of angle φ is about a reference line 143, which extends perpendicular to surface 111a. Hence, contacts 120 are arranged so the potential difference is provided to adapter circuit 130 through contacts 120 for all angles φ.

Power adapter circuit 130 is carried by device 112 for many different reasons. One reason is the desirability to power multiple electronic devices, as discussed with FIG. 3, which may operate in different power ranges. Hence, signal S_{Device} for each electronic device 112 can be different. In some situations, the electronic devices are the same type of device (i.e. two cell phones). The electronic devices can be the same models and have the same power requirements or they can be different models and have different power requirements. The models can be made by the same or different manufacturers.

In other situations the electronic devices are different types of devices (i.e. a cell phone and laptop computer). Different types of devices generally operate within different power ranges, although they can be the same or overlapping ranges in some examples. The different types of devices can be made by the same or different manufacturers. Hence, power adapter circuit 130 for each electronic device can be designed so power delivery system 100 provides power to many different types of electronic devices.

For example, contacts 120 can engage surface 111a without the need to align them with it, so at least two contacts are at different potentials. The arrangement of contacts 120 is also useful when powering multiple electronic devices because they can be positioned in many more different ways on surface 111a. This allows surface 111a to be used more efficiently so more devices can be powered together by structure 111. This is useful in situations where there are not enough power sources available to power the multiple electronic devices individually.

In general, structure 111 can power more electronic devices when the area of surface 111a increases and fewer when the area decreases. In this embodiment, the area of surface 111a is length L multiplied by width W since it is rectangular in shape. Hence, structure 111 can power more electronic devices when length L and/or width W are increased and fewer when length L and/or width W are decreased. The number of electronic devices that structure 111 can carry also depends on their size. For example, cell phones are typically smaller than laptop computers so, for a given area of surface 111a, more cell phones can be carried by it than laptop computers.

FIG. 3 is a top view of power delivery system 100, operatively coupled to electronic devices 401, 402 and 403. In this embodiment, electronic device 401 is embodied as a laptop computer and devices 402 and 403 are embodied as cell phones, which are made by different manufacturers. Each device 401, 402 and 403 includes and carries a corresponding power adapter circuit in communication with corresponding contacts 120, as shown with electronic device 112 in FIG. 2b. However, these features are not shown here for simplicity.

Devices 401, 402 and 403 are arbitrarily positioned on surface 111a at different angles φ. As discussed above, the contacts for devices 401, 402 and 403 are arranged so that devices 401, 402 and 403 can be rotated by angle φ while still being operatively coupled to power delivery support structure 111. Hence, devices 401, 402 and 403 can be rotated as indicated by direction arrows 411, 412 and 413, respectively. It should be noted that devices 401, 402 and 403 can also be rotated in directions opposite direction arrows 411, 412 and 413, respectively, while still being operatively coupled to power delivery support structure 111.

In operation, signal S_{PDS} is provided to the power adapter circuit of each device 401, 402 and 403 when they are operatively coupled to power delivery support structure 111. The power adapter circuit for each device 401, 402 and 403 receives signal S_{PDS} and provides signals S_{Device1}, S_{Device2} and S_{Device3}, in response. Signals S_{Device1}, S_{Device2} and S_{Device3} correspond to a desired amount of power to operate devices 401, 402 and 403, respectively. Signal S_{Device1} is generally within a different power range than signals S_{Device2} and S_{Device3} because device 401 is embodied as a laptop and devices 402 and 403 are embodied as cell phones. Hence, device 401 is a different type of device than devices 402 and 403. Signals S_{Device1} and S_{Device2} can be in the same power range or they can be different since devices 402 and 403 are embodied as cell phones made by different manufacturers. In this way, power delivery system 100 can power multiple electronic devices of the same or different types.

FIG. 4a is a block diagram of power adapter circuit 130, in accordance with the invention. Power adapter circuit 130 can have many different configurations. In one embodiment considered to be more basic the power adapter circuit used for receiving power in an electrically conductive wireless power transfer system would consist of a rectifier circuit. The output of the rectifier circuit constitutes the signal S_{Device}. This may be applicable to a device tolerant of an unregulated or intermittent input voltage such as a heated coffee cup. In another embodiment, the circuit would contain a further energy storage element such as a capacitor to filter the signal S_{Device}. A slightly less basic circuit might further contain a diode and resistor to provide a means of enabling automatic detection of the presence of the device to the circuitry of the power delivery surface. In devices that require a specific input voltage, circuit 130 may contain a rectifier, storage element, and a voltage regulator to generate a well defined signal S_{Device} to the device. In some applications, it may be desirable to provide a signal S_{Device} that directly charges a battery or other storage element in the device. For this case, circuit 130 would contain a rectifier, storage element, and a battery charging circuit.

FIG. 4b is a schematic diagram of one embodiment of a rectifier circuit included in power adapter circuit 130. In this embodiment, circuit 130a includes contact 120a connected to an n-type side of a diode 132a and a p-type side of a diode 132b, contact 120b connected to an n-type side of a diode 132c and a p-type side of a diode 132d, contact 120c connected to an n-type side of a diode 132e and a p-type side of a diode 132f, and contact 120d connected to an n-type side of a diode 132g and a p-type side of a diode 132h. Diodes 132a, 132c, 132e and 132g each have corresponding p-type sides connected to conductive contact 133b and diodes 132b, 132d, 132f and 132h each have corresponding n-type sides connected to conductive contact 133a.

In this embodiment, circuit 130a receives the potential difference from surface 411a through contacts 120 and, in response, flows signal S_{Power} between conductive contacts 133a and 133b. As mentioned above, contacts 120 are arranged so there is a potential difference between at least two of them when they engage surface 111a. Circuit 130a provides the potential difference between any contacts in contacts 120 to conductive contacts 133a and 133b. The potential difference between contacts 133a and 133b is then provided to battery 260 through contacts 139a and 139b as signal V_{Power}. In this way, signal V_{Power} is used as a source of power for power system 131.

FIGS. 5a, 5b, and 5c are perspective views of power delivery systems 103, 104 and 105, respectively, in accordance with the invention. Systems 103, 104 and 105 illustrate different ways that a power signal, such as signal S_{Power}, can be provided to power delivery support structure 111.

In FIG. 5a, system 103 includes a solar power system 220 which provides a power signal to support structure 111 through a power cord unit 113. In this embodiment, solar power system 220 includes a solar panel 221 supported by a stand 222. Power cord unit 113 includes a power cord 113b connected between solar power system 220 and a power adapter 122. Unit 113 also includes a power cord 113a connected between power adapter 122 and support structure 111.

In operation, light incident to solar panel 221 causes the power signal to flow through power cord unit 113. The power signal is adapted by power adapter 122 so it is compatible with power delivery support structure 111. The power signal is then provided to an electronic device (not shown) when it is operatively coupled to power delivery support structure 111, as discussed above.

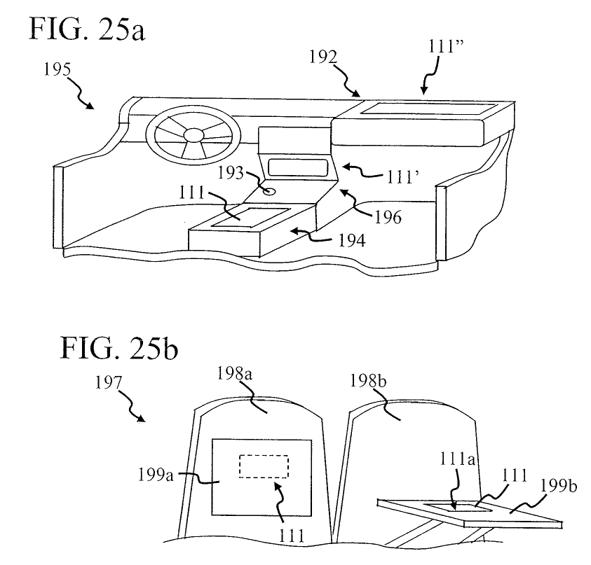

In FIG. 5b, system 104 includes power delivery support structure 111 connected to an adapter 226 through power cord unit 113. Adapter 226 is sized and shaped to be received by a power receptacle of a vehicle. One such power receptacle is that used for a vehicle cigarette lighter, such as receptacle 193 of FIG. 25a. In operation, adapter 226 is connected to the power receptacle and, in response, a power signal flows from the vehicle's power system to power delivery support structure 111 as described with FIG. 5a. This power is then provided to an electronic device (not shown) when it is operatively coupled to power delivery support structure 111, as discussed above.

In FIG. 5c, system 105 includes multiple ways of powering power delivery support structure 111. System 105 is useful in situations, such as when camping, where it is uncertain what types of power sources will be available. Here, system 105 includes adapter 226 connected to power adapter 122 through power cord 113b and an outlet connector 228 connected to power adapter 122 through a power cord 113c. System 104 also includes a solar power system 220′ connected to power adapter 122 through a power cord 113d. Power system 220′ can be of many different types and can have many different configurations, but in this example, it is foldable. Power adapter 122 is connected to power delivery support structure 111 through power cord 113a. In this way, a power signal can be provided to power delivery support structure 111 through plug 226, connector 228, and/or solar power system 220′. This power signal is then provided to an electronic device (not shown) when it is operatively coupled to power delivery support structure 111, as discussed above.

FIGS. 6a, 6b, and 6c are top views of a solar power delivery system 170, in accordance with the invention, in deployed, partially deployed, and stowed positions, respectively. In this embodiment, system 170 includes power delivery system 100 connected to a solar power system 171. Solar power system 171 can have many different configurations. In this embodiment, it includes a plurality of solar panels, denoted as panels 171a, 171b, 171c, 171d, 171e, 171f, 171g, 171h, and 171g, which are operatively connected together. In FIG. 6a, solar panels 171a, 171b, 171c, and 171d extend from sides 115a, 115b, 115c, and 115d, respectively, of electronic system 100. Similarly, solar panels 171e, 171f, 171g, and 171h extend from solar panels 171a, 171b, 171c, and 171d, respectively, and away from power delivery system 100.

System 170 is repeatedly moveable between deployed and stowed positions. System 170 can be moved between its deployed and stowed positions in many different ways. In one example, solar panel 171e is folded towards panel 171a to cover it. Panels 171a and 171e are then folded towards system 100 so they cover it. Solar panel 171f is folded towards panel 171b to cover it. Panels 171b and 171f are then folded towards system 100 so they cover it, as well as panels 171a and 171e. Solar panel 171g is folded towards panel 171c to cover it. Panels 171c and 171g are then folded towards system 100 to cover it, as well as panels 171a, 171b, 171e, and 171f. Solar panel 171h is folded towards panel 171d to cover it, as shown in FIG. 6b. Panels 171d and 171h are then folded towards system 100 to cover it, as well as panels 171a, 171b, 171c, 171e, 171f, and 171g, as shown in FIG. 6c. It should be noted that the panels can be folded together in many other orders, but only one is shown here for simplicity. Further, in one example of moving system 170 from the stowed to deployed positions, the above steps are reversed.

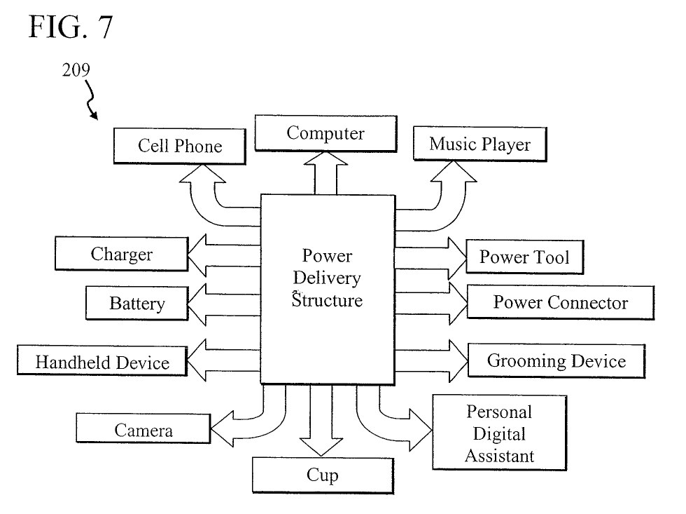

FIG. 7 is a block diagram 209 showing the different types of electronic devices that can be operatively coupled with power delivery structure 111, in accordance with the invention. Some examples of electronic devices include computers, such as laptop and desktop computers. Other examples of electronic devices include toys, game devices, cell phones, chargers, batteries, handheld devices, power tools, power connectors, cups, music players, cameras, calculators, remote controls, video cassette recorders (VCRs), digital video discs (DVD), fax machines and personal digital assistants. Electronic devices also include grooming devices, such as electric shavers, toothbrushes and hair clippers, and appliances, such as televisions and refrigerators. It should be noted that there are other electronic devices that can be operatively coupled with power delivery structure 111, but only a few are discussed here for simplicity.

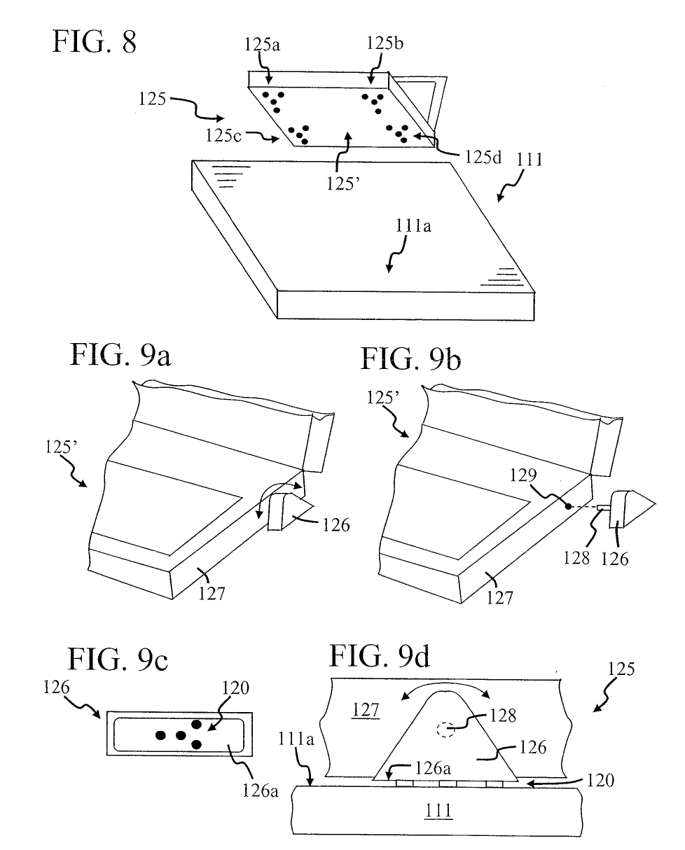

FIG. 8 is a perspective view of power delivery support structure 111 and an electronic device embodied as a laptop computer 125, in accordance with the invention. Laptop 125 carries contacts sets 125a, 125b, 125c and 125d on its bottom surface 125′. When laptop 125 is operatively coupled to power delivery support structure 111, power is provided to it through contacts 125a, 125b, 125c and/or 125d. Contacts 125a-125d are spaced apart from each other so laptop 125 can be positioned in many different positions relative to power delivery support structure 111 so power is provided to laptop 125.

For example, contacts 125a and/or 125b can engage surface 111a so power flows to laptop 125. In this way, laptop 125 can be arranged in many more different ways relative to power delivery support structure 111. Further, if contacts 125a and 125b engage surface 111a, the current flow is shared between them. In this way, less current flows through any one set of contacts, which reduces the current that flows through its corresponding power adapter circuit. If less current flows through the power adapter circuit, its lifetime increases because there is less heating and it is less likely to be damaged.

FIGS. 9a and 9b are perspective views of an electronic device, embodied as a laptop computer 125′, with a power connector 126, in accordance with the invention. In this embodiment, power connector 126 includes and carries contacts 120 extending from its surface 126a, as shown in a bottom view of connector 126 in FIG. 9c. Connector 120 also includes power adapter circuit 130 in communication with contacts 120, as described above, and a battery connector 128. However, circuit 130 is not shown here for simplicity. As with other embodiments disclosed, the embodiment shown in FIGS. 9a and 9b show a conductive delivery of power from the power delivery surface 111a to the device 112, but, as with other embodiments disclosed herein, the power may delivered using other techniques, such as conductive coupling, inductive coupling, optical power deliver, acoustic power delivery, microwave power delivery, or any other power delivery scenario. Laptop 125′ includes a battery power receptacle 129 shaped and dimensioned to receive battery connector 128. Battery power receptacle 129 is usually connected to a power outlet through a power cord unit. Power receptacle 129 extends through a laptop computer housing 127 and is in communication with the power system of laptop 125. In this embodiment, battery connector 128 is repeatably moveable between engaged (FIG. 9a) and disengaged (FIG. 9b) positions relative to power receptacle 129. It should be noted, however, that in other embodiments battery connector 128 can be fixedly attached to power receptacle 129.

FIG. 9d is a side view of connector 126 in its engaged position with surface 111a. In this embodiment, connector 126 is rotatable relative to power receptacle 129, as indicated by the movement arrow, so contacts 120 can be rotatably moved between engaged and disengaged positions relative to power delivery surface 111a. In the engaged position, contacts 120 engage power delivery surface 111a and power is provided to laptop 125 through power receptacle 129. In the disengaged position, contacts 120 are away from surface 111a so power is not provided through them to laptop 125. In this way, connector 126 allows laptop computer 125′ to be operatively coupled with power delivery structure 111. It should be noted that in other embodiments, connector 126 is not rotatable relative to power receptacle 129. In these non-rotatable embodiments, connector 126 can be fixedly attached to power receptacle 129 or it can be repeatably removable therefrom.

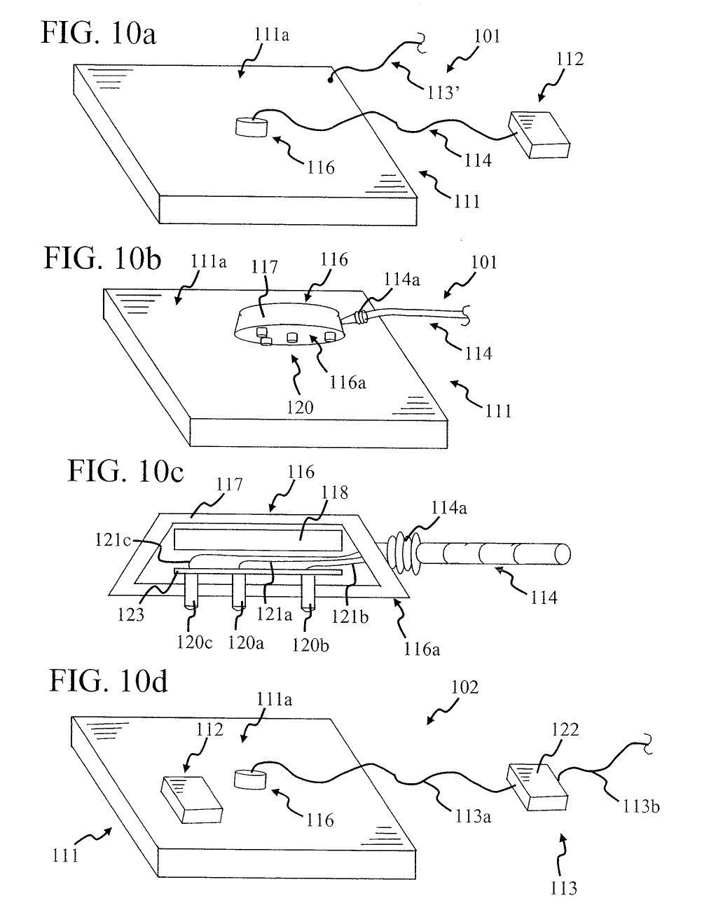

FIG. 10a is a perspective view of a power delivery system 101, in accordance with the invention. System 101 is similar to system 100 and includes power delivery support structure 111 as described in more detail above. One difference, however, is that electronic device 112 is operatively coupled to support structure 111, but it is not carried by it. Instead, system 101 includes an electronic device, embodied as a power connector 116, which is carried by structure 111.

FIG. 10b shows a more detailed perspective view of one embodiment of power connector 116 when it is disengaged from surface 111a. As shown, connector 116 includes a power adapter housing 117 and contacts 120 which extend from its surface 116a. Connector 116 also includes power adapter circuit 130 (not shown) in communication with contacts 120 as described above. Circuit 130 is in communication with electronic device 112 through a power cord 114. It should be noted that in other embodiments, power connector 126 can include magnetic element 300 so that connector 116 is responsive to magnetic field B. Similarly, optical, acoustic, microwave, capacitive, etc. power delivery may also be utilized.

In this embodiment, cord 114 includes a strain relief portion 114a which allows cord 114 to move with more flexibility relative to connector 116. This reduces the likelihood of connector 116 being undesirably moving relative to surface 111a. It should be noted, however, that strain relief portion 114a is included here for illustrative purposes only.

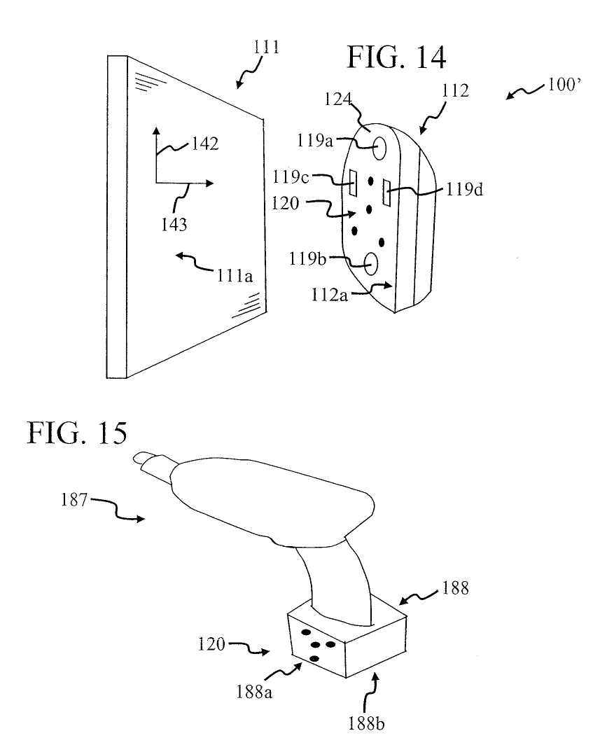

FIG. 10c is a cut-away side view of power connector 116. In this embodiment, connector 116 includes a weight 118 which holds it to power delivery support structure 111 so better electrical contact is made between surface 111a and contacts 120. In one example, weight 118 is magnetic and power delivery support structure 111 includes a magnetic material, as discussed with FIG. 14. Hence, weight 118 and support structure 111 can be magnetically coupled together. Power connector 116 also includes a circuit board 123 mounted within housing 117, which carries contacts 120 and power adapter circuit 130 (not shown). More details about circuit board 123 are provided in co-pending U.S. application Ser. No. 11/672,010, filed on Feb. 6, 2006. Power cord 114 includes separate conductive lines 121a, 121b and 121c, which are connected to corresponding contacts 120a, 120b and 120c of contacts 120. Alternatively, circuit 130 may reside within the housing 116a, thereby the wires that would go out through the cord would be signal S_{Device} and normally consist of a pair of conductors, i.e., one for positive and one for negative.

In operation, contacts 120 engage power delivery surface 111a when power connector 116 is carried by power delivery support structure 111. In response, circuit 130 receives signal S_{PDS} and provides signal S_{Device} to electronic device 112 through unit 114. Hence, power connector 116 is operatively coupled with power delivery support structure 111 through contacts 120. Further, electronic device 112 is operatively coupled with power delivery support structure 111 through power connector 116. In this way, electronic device 112 is operatively coupled with power delivery support structure 111 when it is not carried by it.

FIG. 10d is a perspective view of a power delivery system 102, in accordance with the invention. System 102 is similar to system 101 described above and includes power connector 116. One difference, however, is that power connector 116 is connected to a power source (not shown) through power cord unit 113. Contacts 120 engage surface 111a so connector 116 is operatively coupled with power delivery support structure 111.

In operation, the power source provides power to power adapter 122 through cord 113b. Power adapter 122 adapts the power to a compatible power level and flows it to power connector 116 through cord 113a. Power connector 116 receives the power and flows it to power delivery support structure 111 through power adapter circuit 130 and contacts 120. The power is flowed to structure 111 when contacts 120 engage power delivery surface 111a. This power is then provided to electronic device 112 when it is operatively coupled with support structure 111 as described in more detail above. In this case, circuit 130 is used to deliver power to the pad which otherwise is not energized. In this case, circuit 130 contains sensing circuitry to identify which of its contacts connect to the various electrodes of the power delivery surface. Further circuitry connects the appropriate contacts to a driver circuit within circuit 130 that appropriately energizes the electrodes of the power delivery surface 111a. In this way, a passive set of electrodes comprising an inoperable power delivery surface, is energized to become a fully functional power delivery surface by the device of this invention with the circuit 130. One such purpose of this arrangement may be in cases where it is economical to furnish tables and other surfaces with power delivery electrodes that can later be enabled by an active driver placed on its surface.

For an embodiment that charges batteries, there a typically three types of chargers: 1) a battery charges itself by being placed on a the power delivery surface; 2) a charger that is really just a charge controller that uses the battery to get power from the pad, and then controls the charging of the battery; and 3) a charger that has a power receiver and charge controller and charges dumb, non-pad-enabled batteries such as AA and AAA batteries. For the first case, the battery contains all of the charging intelligence and power reception. In this case, you could just set the battery down on the surface and it would recharge by itself. For the second case, the battery has the power receiver integrated, but does not contain the circuitry to control its own charge (i.e., circuit 130). The battery simply brings the power receiver outputs to terminals on itself that bring the received power into the host device. In this case, there may be a battery charger that contains the battery charging circuit and uses the battery to obtain power from the surface. For the third case, the battery has an integrated power receiver and circuit 130 to generate signal S_{Device}, but not the battery charging intelligence. In this case, a battery charger would use the battery to obtain power from the surface, much like case 2 discussed above.

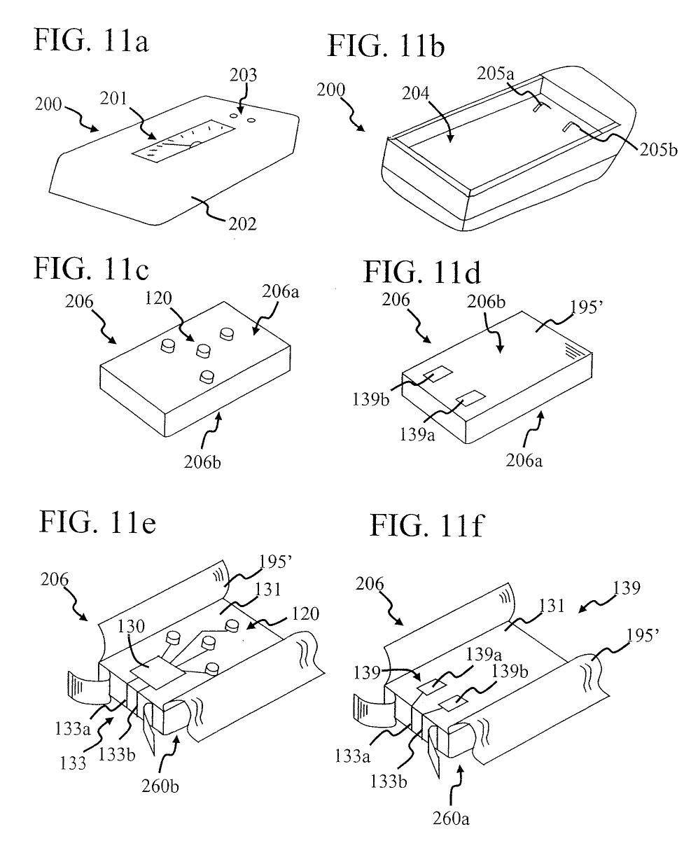

FIGS. 11a and 11b are top and bottom perspective views of a battery charger 200, in accordance with the invention. In this embodiment, battery charger 200 includes contacts 205a and 205b positioned in a battery compartment 204. Contacts 205a and 205b are connected to a power meter 201 which provides an indication of the charging status of battery 206. In this example, battery charger 200 includes lights 203 which indicate when battery 206 is charged. For example, lights 203 can emit red light indicating that battery 206 has a low charge and green light indicating that battery 206 needs to be charged. It should be noted that power meter 201 and lights 203 are optional components, but are shown here for illustrative purposes.

FIGS. 11c and 11d are top and bottom perspective views of an electronic device, embodied as a battery 206, in accordance with the invention. Battery 206 is sized and shaped to be received by battery compartment 204 of charger 200. Battery 206 can be charged when it is operatively coupled to power delivery support structure 111. Battery 206 can be of many different types and can be used to power many different electronic devices. In this example, battery 206 is a rechargeable cell phone battery used to power a cell phone.

In this embodiment, battery 206 includes power adapter circuit 130 (FIGS. 11e and 11f) and contacts 120, which extend through a battery casing 195′ and outwardly from its surface 206a. Battery 206 also includes contacts 139a and 139b which extend through casing 195′ and outwardly from its surface 206b. In this way, contacts 120 and contacts 139a and 139b are carried by and integrated with battery 206.

In operation, battery 206 is positioned in compartment 204 so contacts 139a and 139b engage contacts 205a and 205b, respectively, and power meter 201 provides an indication of the charging status of battery 206 in response. Battery charger 200 is positioned on power delivery support structure 111 so contacts 120 engage surface 111a, as described above, and power flows from surface 111a through contacts 120 and contacts 139a and 139b. In this way, battery charger 200 is used to charge battery 206 using power delivery surface 111a.

FIGS. 11e and 11f are top and bottom perspective views, respectively, of battery 206 with casing 195′ partially unfolded. In this embodiment, battery 206 includes and carries a circuit 130 which is in communication with contacts 120 and operates as a bridge rectifier. Circuit 130 is connected to contacts 139a and 139b through conductive lines 133a and 133b, respectively. Contacts 120 are arranged so there is a potential difference between at least two of them when they engage power delivery surface 111a. Contacts 120 are also arranged so the potential difference is provided to power adapter circuit 130 independently of the orientation of device 112 on surface 111a. In this way, power delivery surface 111a provides the potential difference to circuit 130 through electrical contacts 120 when contacts 120 engage it.

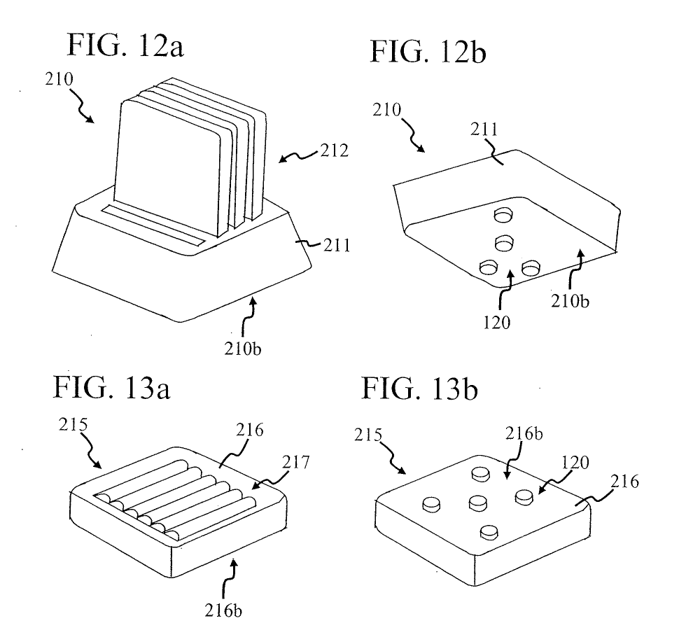

FIGS. 12a and 12b are top and bottom perspective views of an electronic device, in accordance with the invention, embodied as a battery charger 210 which charges batteries 212. In this embodiment, battery charger 210 includes a housing 211 with a plurality of openings for receiving batteries 212. Contacts 120 are carried by battery charger 210 and extend through a surface 210b of housing 211. Battery charger 210 also carries power adapter circuit 130 in communication with contacts 120, but it is not shown for simplicity. The batteries 212 may be any type of battery, but are shown here as cell phone batteries.

In operation, batteries 212 are inserted into corresponding openings so their contacts are in communication with contacts 120 through circuit 130. Battery charger 210 is positioned on power delivery support structure 111 so contacts 120 engage power delivery surface 111a and signal S_{PDS} flows through them to circuit 130. In response, circuit 130 provides signal S_{Device} which is used to charge batteries 212.

FIGS. 13a and 13b are top and bottom perspective views of an electronic device, in accordance with the invention, embodied as a battery charger 215 which charges batteries 217. Batteries 217 are conventional batteries and can be of various sizes, such as A, AA, AAA, etc. Charger 215 includes a housing 216 with a plurality of battery compartments sized and shaped to receive batteries 217. Terminals (not shown) are positioned within each battery compartment to engage corresponding terminals on a battery. The terminals are connected to contacts 120 through power adapter circuit 130 (not shown) and extend through surface 216b of housing 216.

In operation, batteries 217 are inserted into corresponding openings so they are in communication with contacts 120 through circuit 130. Battery charger 215 is positioned on power delivery support structure 111 so contacts 120 engage power delivery surface 111a and signal S_{PDS} flows through them to circuit 130. In response, circuit 130 provides signal S_{Power} which is used to charge batteries 217.

FIG. 14 is a perspective view of an upright power delivery system 100′, in accordance with the invention. In this embodiment, system 100′ includes a power delivery support structure 111 and electronic device 112. Structure 111 is in an upright position wherein surface 111a is perpendicular to the ground as shown in FIG. 1. The surface 111a may be at any non-parallel angle to the ground. Device 112 may be engaged with surface 111a in many different ways, such as with vacuum suction. In this example, however, device 112 is engaged with surface 111a by virtue of magnetic attraction. Here, device 112 includes magnetic elements 119a and 119b and power delivery support structure 111 includes a magnetic material. Magnetic elements 119a and 119b can be housed within an electronic device housing 124 of device 112 or they can extend through it. Device 112 is held to surface 111a by magnetic elements 119a and 119b which magnetically couple to the magnetic material. This increases the force in which contacts 120 engage surface 111. As the contact force increases, the contact resistance decreases and as the contact force decreases, the contact resistance increases.

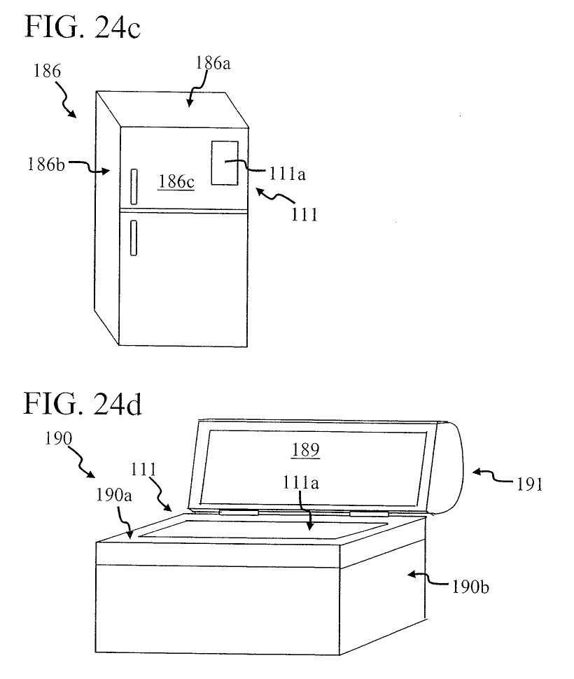

The magnetic coupling is useful in several different situations. For example, power delivery support structure 111 can be attached to a vertical wall, such as the front of a refrigerator, and device 112 can be magnetically coupled thereto. One such embodiment is discussed with FIG. 24c. In another situation, power delivery support structure 111 can be attached to the interior of a motor vehicle, as discussed with FIG. 25a. With a motor vehicle, it is useful to have device 112 held to power delivery support structure 111 so it does not undesirably move.

In this embodiment, electronic device 112 includes friction members 119c and 119d positioned on surface 112a. Friction members 119c and 119d engage surface 111a to increase the amount of friction between device 112 and power delivery support structure 111. In this way, device 112 is less likely to slide relative to surface 111a. Members 119a and 119b can include many different materials, such as rubber and plastic, which provide a desired amount of friction with power delivery surface 111a.

FIG. 15 is a perspective view of a power tool 187 and a power adapter 188, in accordance with the invention. In this embodiment, power tool 187 is embodied as a drill, but it can be another tool, such as a screw driver or saw, or others. Power tool 187 includes a rechargeable battery (not shown) which provides it with power to operate. Power adapter 188 includes contacts 120 and power adapter circuit 130 (not shown) in communication with each other, as discussed above. In this example, contacts 120 extend through a side 188a of adapter 188. However, in other examples contacts 120 can extend through a bottom 188b of adapter 188. In still other examples, contacts 120 can extend through both sides 188a and 188b. This allows power adapter 188 to be operative coupled to power delivery support structure 111 in many more orientations. This also provides redundancy in case one set of contacts 120 become inoperative. Further, having multiple sets of contacts 120 may allow signal S_{PDS} to be divided, as discussed with FIG. 8.

In operation, power tool 187 is operatively coupled to power adapter 188 so its battery (not show) is in communication with contacts 120 through power adapter circuit 130. Contacts 120 are engaged with power delivery surface 111a (FIG. 1) and signal S_{PDS} flows through contacts 120 to power adapter circuit 130. Circuit 130 outputs signal S_{Power} to the battery or charging circuitry of power tool 187 in response. It should be noted that power delivery support structure 111 can be oriented in many different ways, such as those shown in FIGS. 1 and 14 above.

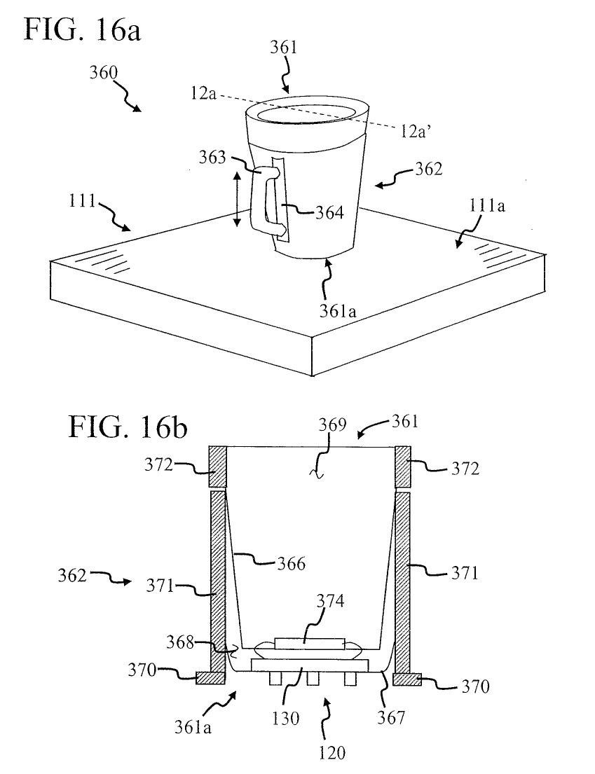

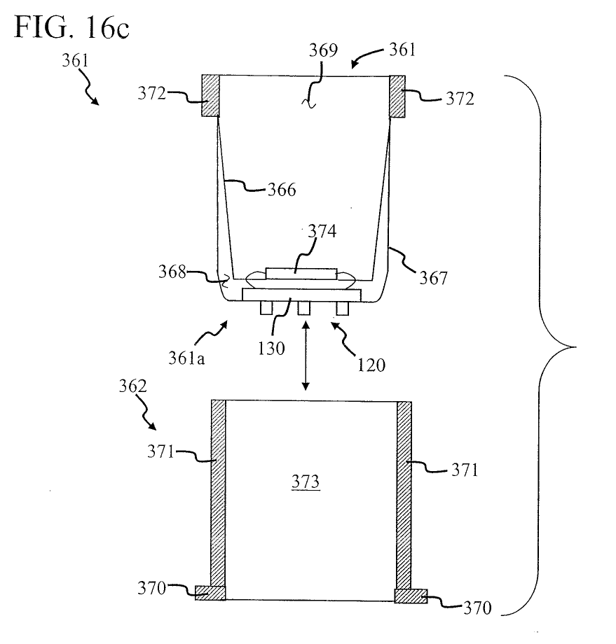

FIG. 16a is a perspective view of a power delivery system 360, in accordance with the invention, wherein the electronic device is embodied as a cup 361 carried by a cup holder 362. Cup 361 and cup holder 362 are carried by power delivery structure 111, as described in more detail below. FIGS. 16b and 16c are sectional side views of cup 361 and sleeve 362 taken along a cut line 12a-12a′ of FIG. 16a. In FIG. 16a, cup 361 is engaged with holder 362 and in FIG. 16b, cup 361 is disengaged from it. Sleeve 362 stabilizes cup 361 and reduces the likelihood of it tipping relative to power delivery surface 111a when carried by power delivery structure 111.

In this embodiment, sleeve 362 includes a sidewall 371 with a central space 373 for receiving cup 361. Sleeve 362 also has an annular flange 370 positioned to provide sleeve 362 with more support when it is carried by power delivery support structure 111. It should be noted that flange 365 is optional and can be molded into sleeve sidewall 364 or it can be a separate piece. It should also be noted that cup holder 362 is also optional and that cup 361 can be configured to operate without it in accordance with the invention.

Cup 361 can be of many different types. In this embodiment, cup 361 includes an inner wall 366 and an outer wall 367 which enclose an inner space 368. Cup 361 has an opening 375 which extends into space 369 for holding a beverage, such as coffee and tea. Cup 361 also includes an annular flange 372 which extends around the outer periphery of opening 375. Cup 362 can be of many different types and generally includes a material, such as metal, plastic and ceramic, that can withstand a wide range of temperatures. The temperature range includes those generally used for beverages.

In accordance with the invention, cup 361 includes contacts 120 which extend through its surface 361a away from opening 375. Further, cup 361 includes power adapter circuit 130 positioned in inner space 368 so it is in communication with contacts 120, as described above. Cup 361 also includes a temperature controller 374 in communication with power adapter circuit 130. Controller 374 can be positioned at many different locations, but here it is on inner wall 366 in space 369. In this way, controller 374 can control the temperature of inner wall 366 and the beverage in space 369. Temperature controller 374 can be of many different types, such as a thermoelectric heater or cooler, which provides a desired temperature in response to a signal from power adapter circuit 130.

In operation, signal S_{PDS} flows to power adapter circuit 130 when cup 361 is carried by power delivery support structure 111 and contacts 120 engage surface 111a. Power adapter circuit 130 provides signal S_{Power} to temperature controller 374 in response to receiving signal S_{PDS}. In this way, temperature controller 374 is powered by power delivery support structure 111 and controls the temperature of cup 362.

In one mode of operation, temperature controller 374 operates as a heater so it drives the temperature of the beverage to a desired high temperature. In another mode of operation, temperature controller 374 operates as a cooler so it drives the temperature of the beverage to a desired low temperature. It should be noted that a high temperature is generally one that is higher than room temperature and a low temperature is one that is lower than room temperature. In some examples, controller 374 can operate as both a heater and cooler so it can drive the temperature of the beverage to a desired high or low temperature. In this way, the temperature of the beverage in space 369 is controlled.

In this embodiment, cup 361 includes a handle 363 which extends through a slot 364 of holder 362 when cup 362 is engaged with holder 362. Handle 363 moves through slot 364 relative to holder 362 when cup 362 is moved away from power delivery surface 111a. It should be noted that handle 363 and slot 364 are optional components and are shown for illustrative purposes. Cup 361 is repeatedly moveable between engaged (FIG. 16b) and disengaged (FIG. 16c) positions relative to sleeve 362. In the disengaged position, cup 361 is moved upwardly and away from sleeve 362 so flange 372 is disengaged from sleeve sidewall 371.

Cup 361 and sleeve 362 can be moved relative to each other in many different ways. Here, when cup 361 is lifted by handle 363, sleeve 362 slides upwards and catches flange 372 and cup 361 is moved away from surface 111a in response. When cup 361 is engaged with surface 111a, sleeve 362 slides down until it engages surface 111a.

The positioning of cup 361 relative to sleeve 362 when in the engaged position can be adjusted to adjust the engagement force between contacts 120 engage surface 111a. As the engagement force between contacts 120 and surface 111a increases, the contact resistance between them decreases. Further, as the engagement force between contacts 120 and surface 111a decreases, the contact resistance between them increases.

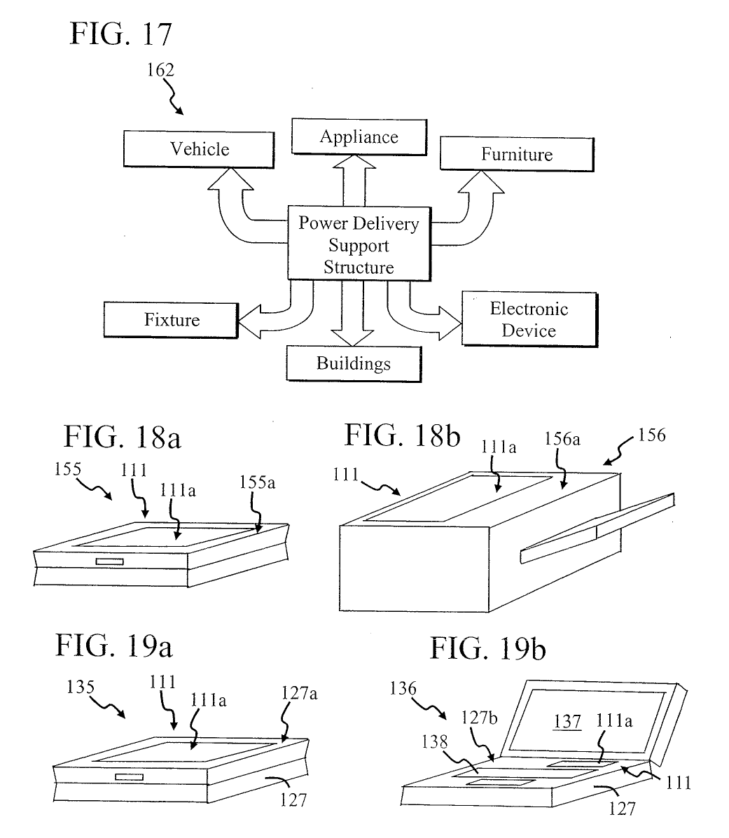

FIG. 17 is a block diagram showing the different places that a power delivery system, in accordance with the invention, can be used. In some embodiments, the power delivery system is used in buildings, which generally includes residential and commercial buildings. The residential and commercial buildings can be of many different types, such as homes, businesses, cabins, hotels, etc. It should be noted that in some embodiments, the power delivery system can be used outdoors, such as when camping.

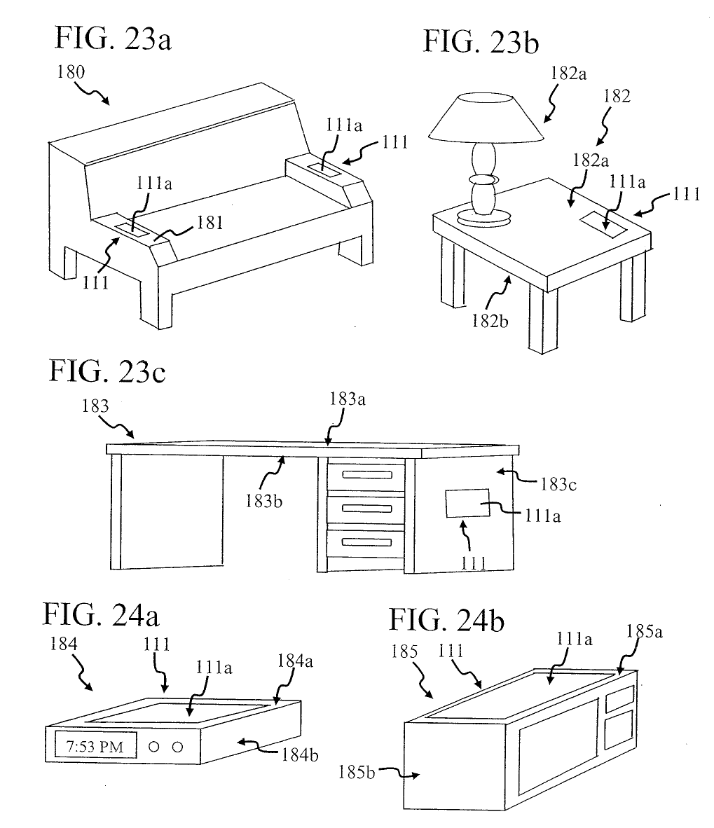

The power delivery system can also be used with many different apparatuses. For example, as shown in FIGS. 18a-18b, 19a-19b, 20, 21a-21b and 22, the power delivery system can be used with an electronic device. In FIGS. 23a, 23b and 23c, the power delivery system is used with a piece of furniture. As shown in FIGS. 24a, 24b, 24c and 24d, the power delivery system is used with an appliance. In other embodiments, the power delivery system is used with a vehicle, such as a motor vehicle, marine vessel or an airplane. For example, the power delivery system is used with a motor vehicle and an airplane as shown in FIGS. 25a and 25b, respectively. In this way, these apparatuses can be used to provide power to other electronic devices, as discussed above.

FIGS. 18a and 18b are perspective views of electronic devices, in accordance with the invention, embodied as a scanner 155 and printer 156, respectively. In this embodiment, scanner 155 includes power delivery support structure 111 so surface 111a defines a portion of its upper surface 155a and printer 156 includes power delivery support structure 111 positioned so surface 111a defines a portion of its upper surface 156a. Power to power delivery surface 111a can be provided by the power system of scanner 155 or printer 156, or from a separate power cord unit (not shown).

FIG. 19a is a perspective view of an electronic device, in accordance with the invention, embodied as a laptop computer 135. In this embodiment, laptop 135 includes power delivery support structure 111 positioned so surface 111a defines a portion of an outer surface 127a of laptop housing 127. In some examples, the power system of laptop 135 provides power delivery surface 111a with power. In other examples, the power is provided to surface 111a independently of the power system of laptop 135. For example, a separate power cord unit can extend from laptop 135 and connect power delivery surface 111a to an electrical outlet.

FIG. 19b is a perspective view of an electronic device, in accordance with the invention, embodied as a laptop computer 136. In this embodiment, laptop 136 includes a display 137 and a keyboard 138 which extend through an inner surface 127b of housing 127. Laptop 136 also includes power delivery support structure 111 positioned so surface 111a defines a portion of surface 127b. Surface 111a can be provided with power in a manner the same or similar to that discussed above with laptop 135.

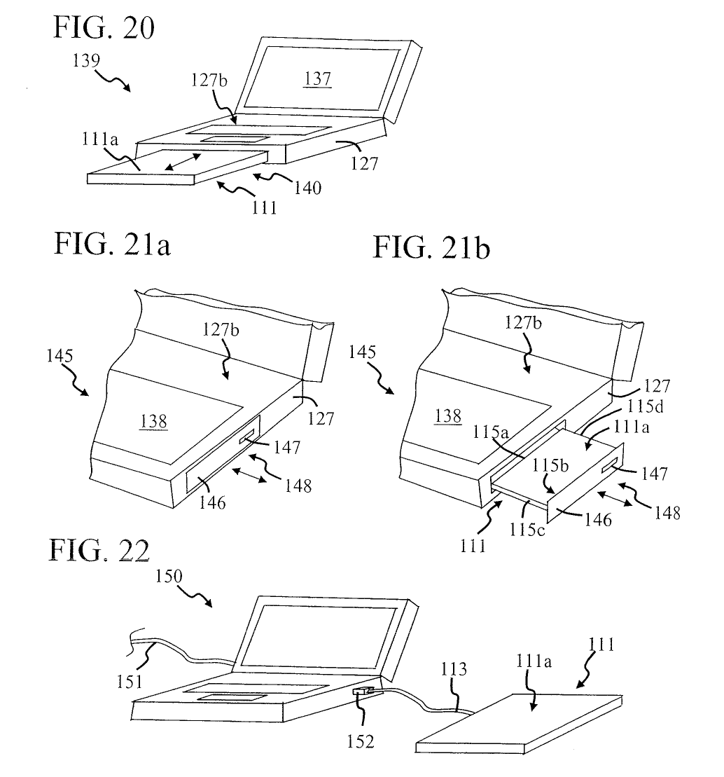

FIG. 20 is a perspective view of an electronic device, in accordance with the invention, embodied as a laptop computer 139. In this embodiment, laptop 139 includes a tray 140, which is moveable, as indicated by the movement arrow, between a deployed position (shown) and a stowed position (not shown) relative to a front portion of laptop 139. Laptop 139 includes power delivery support structure 111 which is carried by tray 140 and is also moveably therewith. When tray 140 is in its deployed position, electronic device 112 can be carried thereon and powered, as discussed above, by power delivery surface 111a. When tray 140 is in its stowed position, it occupies a cavity (not shown) inside housing 127.

Tray 140 can be moved between its stowed and deployed positions in many different ways. In one example, it is held by rails so it can slide towards and away from housing 127. In another example, it is attached to a tongue which engages a groove carried by housing 127. In some examples, tray 140 can include a handle so it can be pulled from its stowed position to its deployed position.

FIGS. 21a and 21b are perspective views of an electronic device, in accordance with the invention, embodied as a laptop computer 145. In this embodiment, computer 145 includes a tray 148 which is moveable, as indicated by the movement arrow, between a stowed position (FIG. 21a) and a deployed position (FIG. 21b) relative to a side of housing 127. In the stowed position, tray 148 is flush with the side of housing 127. Tray 148 is moveable from the stowed position to the open position in response to activating a button 147. In this way, tray 148 operates in a manner similar to that of a CD ROM drive or a DVD player.

In this embodiment, power delivery support structure 111 is carried by tray 148 and is moveable therewith. Power delivery surface 111a can obtain its power from the battery or power system of laptop 145. When needed, tray 148 is deployed to expose surface 111a so an electronic device can be carried thereon. When not needed, tray 148 is stowed and door 146 is latched to housing 127 so it is held in the stowed position. Tray 148 is designed to support the weight of electronic device 112.

In some examples, an existing computer component, such as a CDROM drive or a DVD player is already installed in laptop 145. In accordance with the invention, this already installed component can be removed from laptop 145 and replaced with tray 148. In other embodiments, tray 148 can be a built in feature with laptop 145. In still other embodiments, the tray of an already existing CDROM drive or a DVD player is modified so it carries power delivery surface 111a. In this way, it can be used to play a CD or DVD and to power an electronic device.

FIG. 22 is a perspective view of an electronic device, embodied as a laptop computer 150, connected to power delivery support structure 111, in accordance with the invention. In this embodiment, laptop 150 is connected to an electrical outlet (not shown) with a power cord unit 151. Power delivery support structure 111 receives power from laptop 150 through a power cord 113 connected to a battery power connector 152 of laptop 150. In this way, power is flowed between laptop 150 and power delivery surface 111a through cord 113. The power can be provided by the batteries in laptop 150 or it can be flowed directly from unit 151.

Power connector 152 may be of many different types, such as those normally used to connect a laptop to a power source. In some embodiments, power delivery surface 111a may operate as a mouse pad which provides power to a computer mouse. In other examples, surface 111a may operate as a touch pad for providing information to a computer.

In accordance with the invention, a plurality of separate power delivery systems are positioned at the same or different locations to provide a wire-free recharging infrastructure. A “wire-free” recharging infrastructure is one that does not require power cord units connected between the power source and electronic device being charged. With this infrastructure, a user of an electronic device is able to recharge and operate the electronic device wire-free and without the need to carry a battery charger. The power delivery surface 111a may still require a power cord, but the individual electronic devices do not require power cords, and are therefore wire-free.

If enough power delivery systems are provided, a user is more likely to be able to use one. In some situations, the power delivery system is provided as a convenience to the user by the business hosting the wire-free infrastructure and, in other situations, the user is charged by the business.

The infrastructure can be provided in a discrete fashion by integrating it with various structures. For example, it can be integrated with a sofa, table and desk, as discussed with FIGS. 23a, 23b, and 23c, respectively. In this way, the infrastructure is more discrete. There are also fewer power cord units at the location, so people are less likely to lose or trip over them.

FIG. 23a is a perspective view of a piece of furniture, in accordance with the invention, embodied as a couch 180 having power delivery support structure 111. In this embodiment, power delivery support structure 111 is carried on an arm 181 of couch 180. However, power delivery support structure 111 can be positioned at many other different locations on couch 180. In this embodiment, power delivery support structure 111 can be used to charge a remote control device for a television and the other electronic devices discussed above. The power cable which provides power to power delivery support structure 111 extends from an electrical wall outlet (not shown) through couch 180 and to power delivery surface 111a so it is hidden from view.

FIG. 23b is a perspective view of a fixture, embodied as a table 182, with a power delivery support structure 111, in accordance with the invention. In this embodiment, power delivery support structure 111 is carried on an upper surface 182a of table 182. However, power delivery support structure 111 can be positioned at many other different locations on table 182, such as on a lower surface 182b. The power cable which provides power to power delivery surface 111a extends from an electrical wall outlet (not shown) and to power delivery surface 111a. It should be noted that lamp 182a can be powered by a power cable connected to the wall outlet or it can be powered by a power delivery support structure 111 (not shown). In this way, the power cable is hidden from view so the fixture is more aesthetically pleasing.

FIG. 23c is a perspective view of a fixture, embodied as a desk 183, with power delivery support structure 111, in accordance with the invention. In this embodiment, power delivery surface 111a is carried on a side 183c of desk 183. However, power delivery surface 111a can be positioned at many other different locations on desk 183, such as an upper surface 183a and a lower surface 183b. Power delivery surface 111a is powered by a power cord unit connected from a wall outlet (not shown) and power delivery surface 111a. The power cord unit is hidden from view to make desk 183 more aesthetically pleasing. In some embodiments, power delivery surface 111a is held to desk 183 by an adhesive or a magnetic force, as discussed with FIG. 14.

FIG. 24a is a perspective view of an appliance, embodied as a digital clock 184, with power delivery support structure 111, in accordance with the invention. In this embodiment, power delivery support structure 111 is carried on an upper surface 184a of clock 184. However, power delivery support structure 111 can be carried at many other different locations on clock 184, such as a side surface 184b. In some embodiments, clock 184 can be powered by a power delivery support structure (not shown) or it can be powered by a power cord unit.

FIG. 24b is a perspective view of an appliance, embodied as a microwave oven 185, with power delivery support structure 111, in accordance with the invention. In this embodiment, power delivery support structure 111 is positioned on an upper surface 185a of oven 185. However, power delivery support structure 111 can be positioned at many other different locations on oven 185, such as a side surface 185b.

FIG. 24c is a perspective view of an appliance, embodied as a refrigerator 186, with a power delivery surface in accordance with the invention. In this embodiment, power delivery support structure 111 is positioned on a front side surface 186ca of refrigerator 186. However, power delivery support structure 111 can be positioned at many other different locations on refrigerator 186, such as a side surface 186b and an upper surface 186a.

FIG. 24d is a perspective view of a tool box 190 with a power delivery surface, in accordance with the invention. In this embodiment, tool box 190 includes a lid 191 which carries a solar power system 189. Power delivery support structure 111 is carried on a surface 190a which can be enclosed by lid 191. Solar power system 189 is connected to power delivery support structure 111 and provides power to it. Some examples of solar power systems connected to power delivery support structure 111 are discussed with FIGS. 5a-5c and 6a-6c. Lid 191 is repeatedly moveable between open and closed positions relative to surface 190a. The tool box can be an exterior tool box often carried in the back of a pick-up truck. It can be under the hood of the car. A bed accessory often carried in the cargo bed of a pick-up truck. It can be on a sidewall of the bed or the tailgate. The tool box can include contacts on its bottom which connect to a power delivery surface on the bottom of the bed. The power delivery surface is powered by the vehicle electrical system and is used to charge power tools. It can be integrated with a camper or a tent. It can be integrated with a camper shell for a truck. It can be integrated with a truck and with construction vehicles. It can be integrated with a trailer. For example, it can be used as the connector for the tail lights of a trailer. Truck bed toolbox.

FIG. 154 shows a toolbox or utility box with a power delivery surface mounted on a surface. In this example another panel houses a solar panel to power the system. In one embodiment, such toolbox or utility box may be affixed and mounted on a vehicle such as the back of a pickup truck or inside a cargo bay, and receive power from the vehicle battery. This is a useful application for construction workers who can recharge their hand-held power tools while in or on the toolbox.

FIG. 25a is a perspective view of the interior of a motor vehicle, embodied as car 195, having power delivery support structure 111, in accordance with the invention. Power delivery support structure 111 can be positioned in many different locations with car 195. For example, a console 194 separating the driver and passenger sides can carry power delivery support structure 111. Power delivery support structure 111 can also be positioned at an intermediate location between console 194 and dash board 192, as indicated by power delivery support structure 111′. Power delivery support structure 111 can be positioned on dash board 192, as indicated by power delivery support structure 111″.

Power delivery support structures 111′ and 111″ are the same or similar to power delivery support structure 111. In these examples, support structure 111 can include a magnetic material, as discussed with FIG. 1b, so it holds electronic device 112 while vehicle 195 is moving. It should be noted that in other examples, power delivery support structure 111 can even be positioned on the exterior of car 195, but these embodiments are not shown here for simplicity.

Power delivery support structures 111, 111′, and/or 111″ can be powered in many different ways when included with car 195. In some examples, they are wired to the electrical system of car 195. This can be done directly or it can be done through a power connector, such as cigarette lighter 193. Examples of power delivery support structure 111 powered by a power connector embodied as a cigarette lighter are shown in FIGS. 5b and 5c. Support structure 111 can also be positioned in the trunk of a car or in an exterior tool box carried by a pick-up truck. It is also useful to position support structure 111 at the exterior of a vehicle, such as under the hood. This is useful to power many different electronic devices, such as a power tool.

FIG. 25b is a perspective view of a vehicle, embodied as an airplane, which includes airplane seating 197 having power delivery support structure 111, in accordance with the invention. In this embodiment, power delivery support structure 111 is carried by a tray table 199a, which is repeatedly moveable between open and closed positions. In this example, a seat 198a carries a tray table 199a which has power delivery support structure 111. Tray table 199a is shown as being in its closed position. A seat 198b carries a tray table 199b which has power delivery support structure 111 integrated with it. Tray table 199b is shown as being in its open position. The plane can be a commercial plane or it can be a private plane. In some embodiments, power delivery support structure 111 can be integrated with an arm of seat 198a and 198b instead of a tray. Support structure 111 can also be integrated with the back of seat 198a and 198b and include the magnetic material as discussed with FIG. 1b.

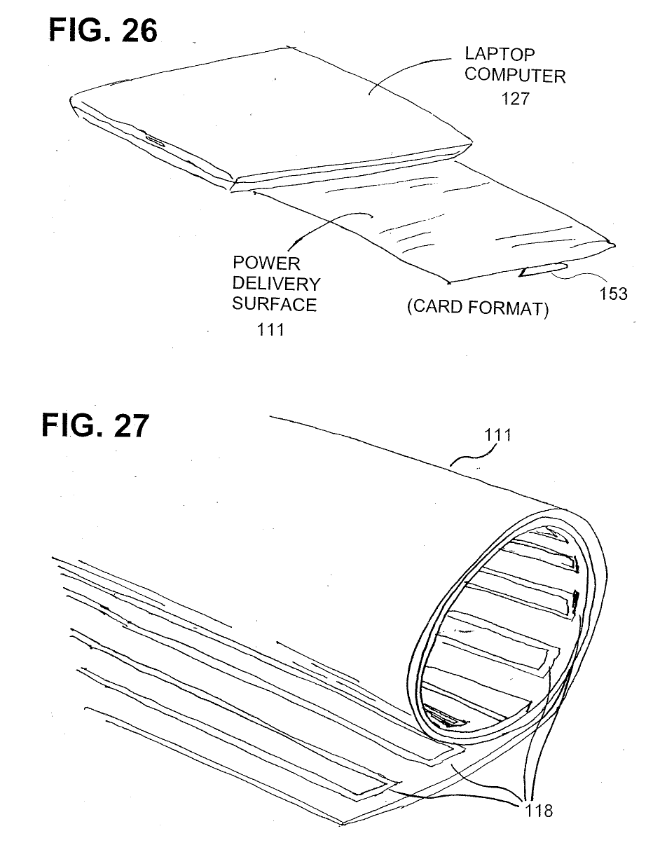

FIG. 26 is a perspective view of a stowaway power delivery surface in which in which the power delivery surface 111 slides into a very thin slot under the device 127, such as a laptop computer as shown. When the power delivery surface 111 is extended, it rests on a presumably flat surface. The weight of whatever device is set upon the surface 111 is born by the surface upon which the power delivery surface rests. When stowed, the card 111 may occupy a flat cavity inside the host device 127. Alternatively, the card 111 may be held in place by a tongue and groove type channel on either side. In this case the bottom surface of the pad 111 would always be exposed. Another option is that the power delivery surface 111 could roll up into a tube around a spring-loaded shaft as it is retracted. A flexible wiring connection is needed to connect power to energize the power delivery surface 111. In the case of a rollup mechanism, a slip ring assembly may be used. A tab 153 as shown in the figure allows the user to pull the ‘card’ out when stowed.

FIG. 27 is a perspective view of a rolled-up power delivery surface 111. A power delivery surface 111 may be rolled into a cylinder which may, for example, aid in transporting the device, or storing the device. To facilitate rollability, the substrate should be readily bendable, and/or compressible or expandable. In addition, the thinner the substrate can be made, the easier it will be to roll. In the case of a power delivery surface 111 with conductors on a face where the conductive pattern is heterogeneous, it is best if the longest dimension of the surface electrodes are aligned parallel to the axis about which the surface will be rolled. Shown is an example of a substrate 111 with a pattern of conductive strips 118 adhered to it having been rolled up along an axis parallel to the long dimension of the strips 118.

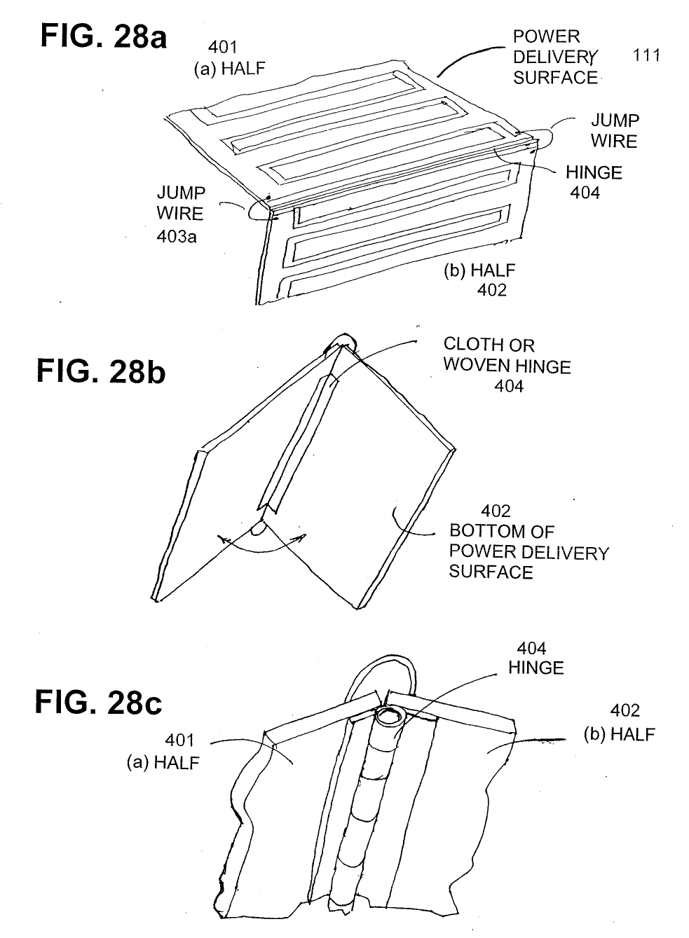

FIGS. 28a, 28b, and 28c are perspective views of folded power delivery surfaces. A power delivery surface 111 can be economically constructed to be foldable. The hinges 404 and interconnections are carefully chosen to make folding viable. FIG. 28a shows a conductive-based power delivery surface 111 split in two along the line that formed a gap between two strips of conductors. A conductor 403a, 403b connects the “positive” surface electrodes on the (A) half 401 with the “positive” surface electrodes of the (B) half 402. A similar conductor 403a, 403b on the opposing side connects the “negative” surface electrodes of the (A) half 401 to the “negative” surface electrodes of the (B) half 402. FIG. 28b shows that the hinge 404 itself may be formed of a durable cloth or other woven fiber strip adhered to the back side of the power delivery surface 111. A standard hinge such as found on a door 404 could also be directly molded or adhered to the bottom of the power delivery surface 111 as shown in FIG. 28c.

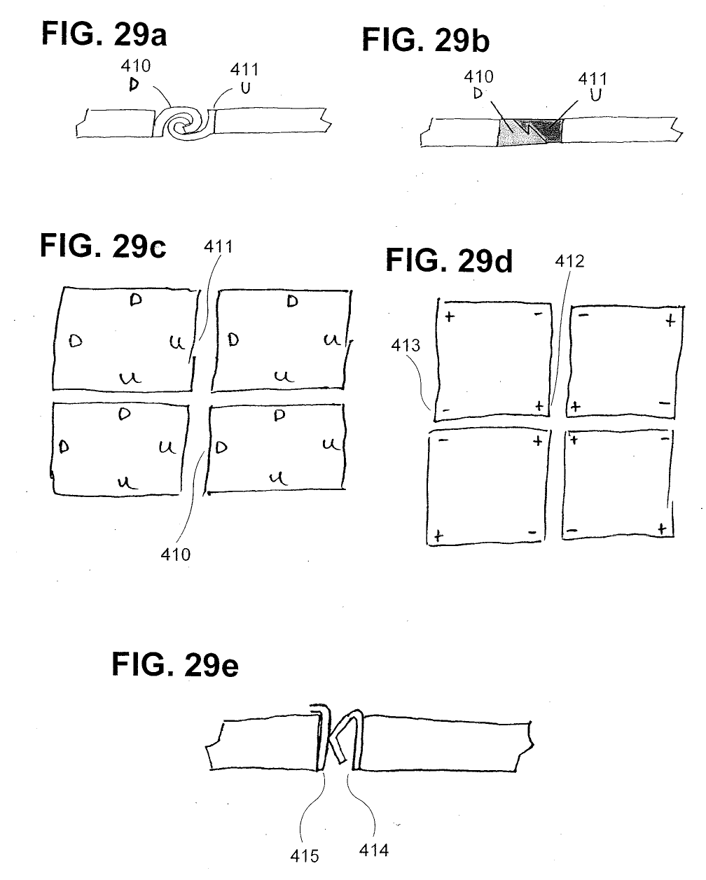

FIGS. 29a and 29b show perspective views of interlocking mechanisms to attach adjacent power delivery surfaces. Power deliver surface pads may be dynamically connected to each other (cascaded), thus, enlarging the active area in size while receiving power through a single connection. Power delivery surfaces may be placed adjacent to each other in order to increase the effective power delivery area. FIGS. 29a and 29b show a ‘polarized’ interlocking mechanism to mechanically attach adjacent power delivery surfaces. The two ‘polarities’ are labeled ‘U’ 410 and ‘D’ 411.

FIG. 29c shows a schematic view of the placement of multiple interconnecting power delivery surfaces with the appropriate sides marked for proper mechanical attachment. In FIG. 29c four power delivery surfaces are arranged in a 2×2 matrix. The U 410 and D 411 interlocking tabs are arranged on each power delivery surface as shown. This allows an N×M matrix to be assembled where all the adjacent power delivery surfaces mate.

FIG. 29d shows a schematic view of the placement of multiple interconnecting power delivery surfaces with the appropriate corners marked for proper electrical attachment. The corners of the power delivery surfaces 412, 413 may have contacts as shown in FIG. 29e such that when two power delivery surfaces are interlocked, a connection between the two surfaces is formed. Hence, a matrix of power delivery surfaces may be connected together to make a larger power delivery surface powered by a single power supply.

FIG. 29e shows a perspective view of the electrical attachment at the corner of multiple attached power delivery surfaces. The contacts 415 on each corner of a particular power delivery surface are in electrical contact with the contacts 416 at the diametrically opposed corner of another power deliver surface. The corners should be connected such that all corner polarities match (i.e., all corners are positive 412 or negative 413).

A power delivery surface may also be collapsible by means of a sliding mechanism. In this case, a power delivery surface is divided into multiple segments. Adjacent segments slide one under another to collapse. One embodiment may call for a tongue in groove arrangement whereby each segment has a set of grooves on opposing edges on their underside, and mating “tongues” on their opposing edges of their topsides. The topside tongue of one segment mates and slides into the grooves on the underside of adjacent panels.

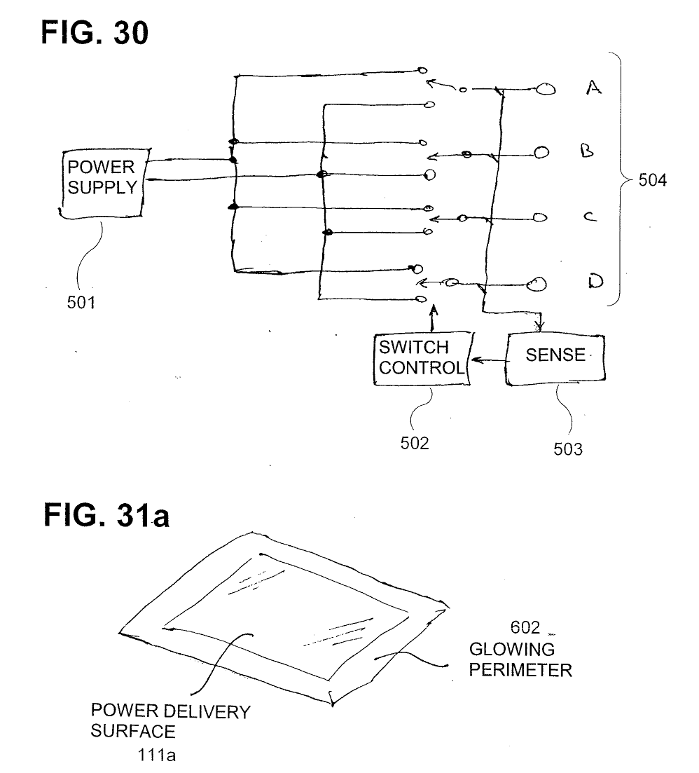

FIG. 30 is a block diagram of a circuit within the power connector 116 described with respect to FIGS. 10a, 10b, 10c, and 10d. When the device is set upon the passive power delivery surface 111a, a combination of contacts can be open, connected to one set of surface electrodes, or connected to another set of surface electrodes. In the present embodiment, sense logic 503 determines which of the contacts A, B, C, or D 504 are connected to each other, and which contacts 504 are not connected at all. Once the connection of each of the contacts 504 is determined, the switch controller 502 sets each switch to route it to the appropriate terminal of the power supply 501, thus, energizing the power delivery surface 111a.

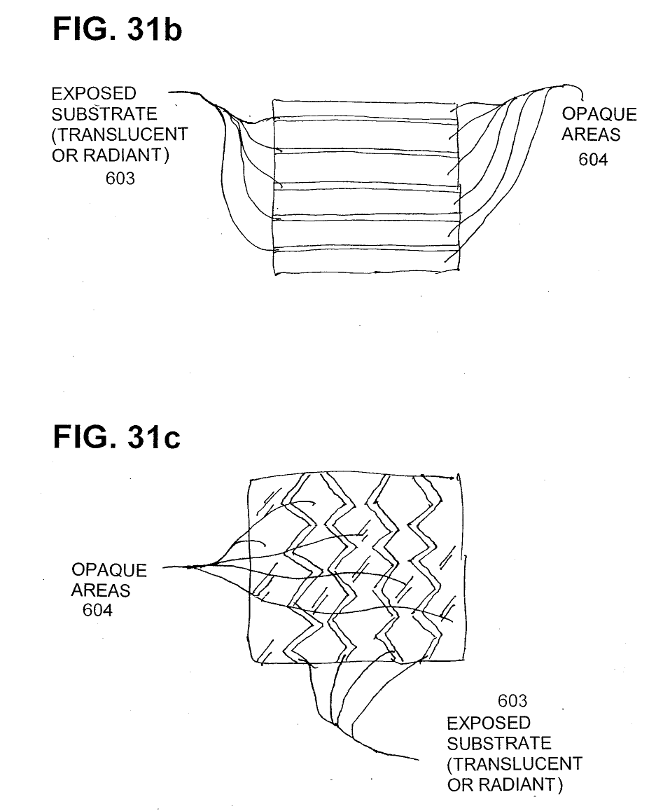

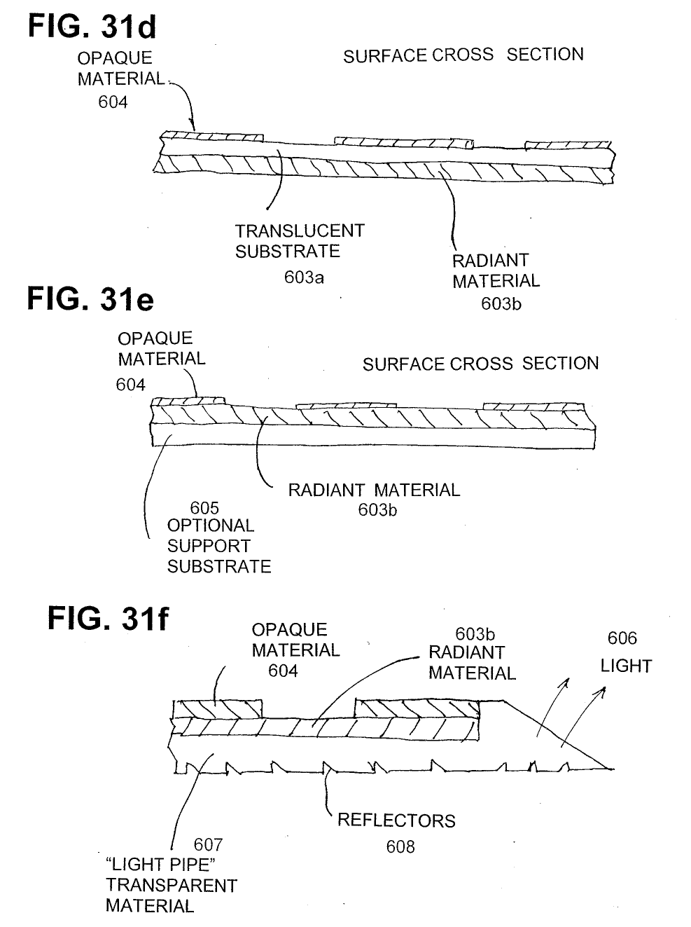

FIGS. 31a, 31b, 31c, 31d, 31e, and 31f are perspective drawings of apparatuses providing functional and aesthetic illumination for a power delivery surface. The illumination may be in the form of a glowing perimeter ring of light 602, a backlight that is visible through a translucent pad substrate 603, or lighting visible through the gaps between the pad contacts. Illumination may be generated by incandescent light, light pipe, electroluminescent, Light Emitting Diodes (LED), or other such light sources. FIG. 31a shows an example of a power delivery surface 111a bordered by a glowing perimeter 602 of electroluminescent (EL) or otherwise radiant material. The shape and styling of the boarder may be other than the simple boarder shown. FIGS. 31b and 31c show a different implementation of illumination. In these examples, the substrate 603 in which opaque material 604 is resting on may be made to be translucent or radiant to achieve the effect of illuminant patterns on the power delivery surface 111a. FIG. 31d shows a cross section of the power delivery surface 111a in the case where light is visible from the top surface shining between opaque material 604 on the surface through a translucent or transparent substrate 603a. In this case the opaque material 604 is primarily supported by a substrate that is either transparent, or translucent 603a. This sandwich sits atop a layer of radiant material 603b. Light generated by the radiant material 603b, passes through the translucent or transparent substrate 603a, and emerges between patches of opaque material 604. FIG. 31e shows a cross section of the power delivery surface 111a in another configuration. In this case, the opaque material 604 on the top layer is affixed directly to the radiant material 603b. Light can emerge from the radiant material 603b directly between the patches of opaque material 604 forming the surface. The radiant material 603b may be further supported by an optional substrate 605 forming a bottom surface. This bottom substrate 605 may allow for further rigidity, greater durability, or for other reasons.

FIG. 31f shows another configuration similar to that of FIG. 31e only the bottom substrate 605 is composed of a substantially transparent material used as a “light pipe” 607. The light generated from the bottom side of the radiant material 603b may be captured and guided to the edges of the power delivery surface 111a. Optional reflectors 608 are shown that form grooves or indentations in the bottom most surface of the transparent material 603b. These reflectors 608 tend to steer the radiant light 606 toward the outer edges of the power delivery surface. At the perimeter of the power delivery surface, further grooves or indentations in the bottom surface 608 tend to deflect the radiant light 606 upwards and outwards so that the effect is to create a glowing frame around the perimeter of the power delivery surface 111a. The drive for the illumination may be derived from the excitation of the power delivery surface 111a. In such a case, the illumination would follow, to a degree, the status of the pad 111a. For example, the illumination would dim when the power delivery surface goes into a “sleep” mode. Alternatively, the illumination may be controlled independently of the excitation applied to the power delivery surface 111a. In such a case, the illumination may be made to change in response to various status levels of the power delivery system, or for aesthetic reasons. The illumination may also be made to change color or dim, to convey information such as “device charging” and “fault,” or for aesthetic reasons.

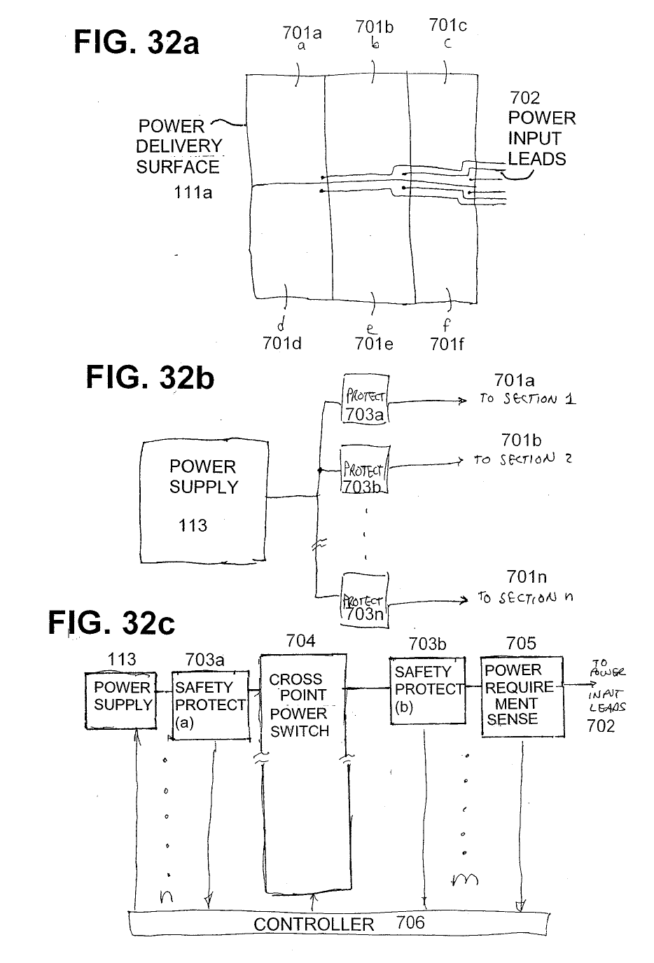

FIG. 32a is a schematic drawing of a power delivery surface 111a broken down into several independent sections 701a-f. Each section 701a-f is powered by the same power supply 113, but through independent undercurrent sensors 703a-f. As a result, much of the pad 111a may not be energized at any given time. In another embodiment, the different sections of the power delivery surface 701a-f may be configured to provide different voltages, or other electrical characteristics, for different areas of the pad. In one embodiment, the pad is composed of an array of independent pads 701a-f. Each independent pad 701a-f may be connected to one of a set of power supplies of unique, predetermined voltages or other electrical characteristics. The pad 701a-f detects the power requirements of the device 112 using a programming resister technique. In this way, the pad may deliver a compatible voltage to devices without the need for a converter on-board the device 112. The sections 701a-f of the power delivery surface 111a may be divided into many sections 701a-f that are electrically independent of each other such that different sections 701a-f may provide different excitations. It is also desirable that the different sections 701a-f are independent so that each section 701a-f may perform independent safety and status testing regardless of the activity on other sections. FIG. 32a shows a power delivery surface 111a divided (arbitrarily, for the purpose of simplicity) into six sections 701a-f. Each section provides a power input lead 702. In one embodiment, the six sections 701a-f are completely electrically isolated from each other, although they may share a common ground.

FIGS. 32b and 32c are schematic block diagrams of power delivery and protection circuits for a power delivery surface 111a broken down into several independent sections. FIG. 32b shows a block diagram of the electrical system to drive the independent sections of the power delivery surface of FIG. 32a. An economy is realized because each independent section shares a common power supply 113. Each section is connected through a protection circuit 703a-n that detects various fault conditions that may be present on various sections 701a-n. Thus, the power delivery surface 111a is safer and more efficient.

FIG. 32c shows an embodiment whereby any of n power supplies may be connected to any of m power delivery surface sections 701a-n. Each power supply 113 drives a safety protection circuit 703a-n. Ellipses are shown to indicate that the blocks repeat for n or m times. A controller 706 monitors input from each safety protection circuit 703a-n, the power requirement sensor 705, and each power supply 113. The controller 706 determines from the power requirement sensors 705 which power delivery surfaces 111a needs to be connected to which power supply 113. Safety protection may be used at either location (a) 701a, location (b) 701b, or both locations 701a, 701b. In the case of the safety protection circuit (a) 703a, it protects the power supply 113 it is connected to. If one of the sections 701a-f powered by this power supply 113 caused a fault, for example, then safety protection circuit (a) 703a would shut down its output and all the sections connected to the output of safety protection circuit (a) 703a by the crosspoint power switch 704 would also be shut down. Safety protection circuit (b) 703b protects the particular section 701a-f it is directly attached to. In this case, a fault on a particular section 701a-f would disable only that particular section through the safety protection circuit (b) 703b.

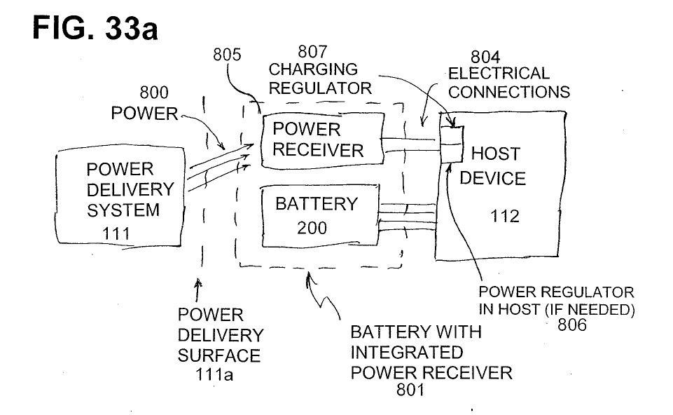

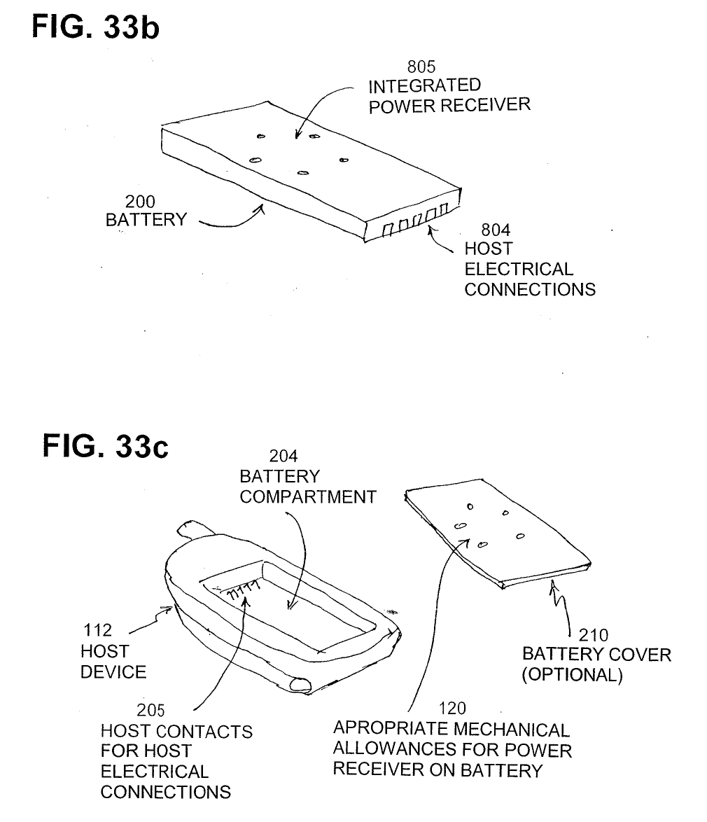

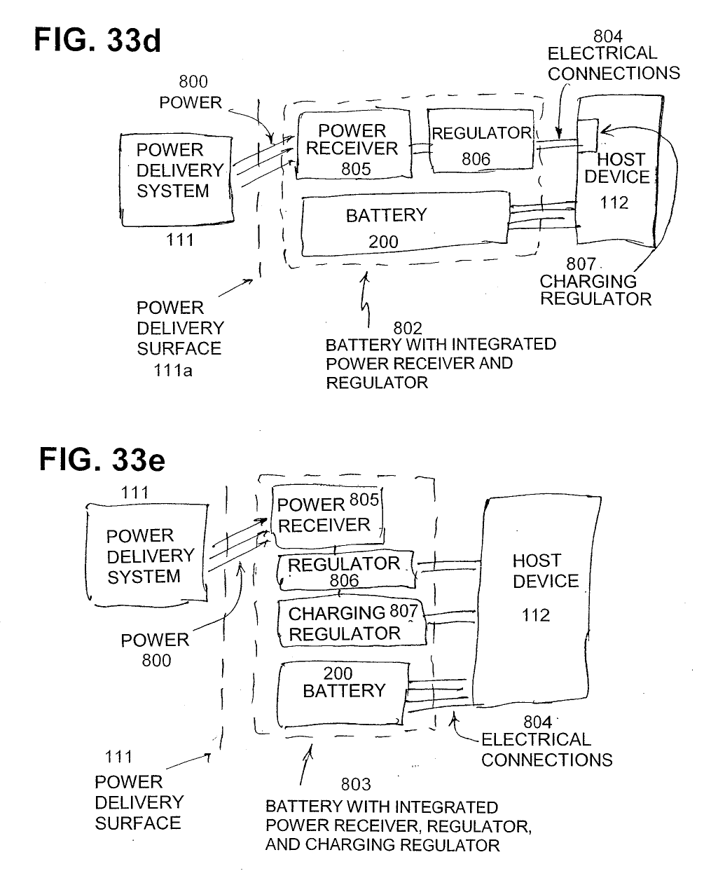

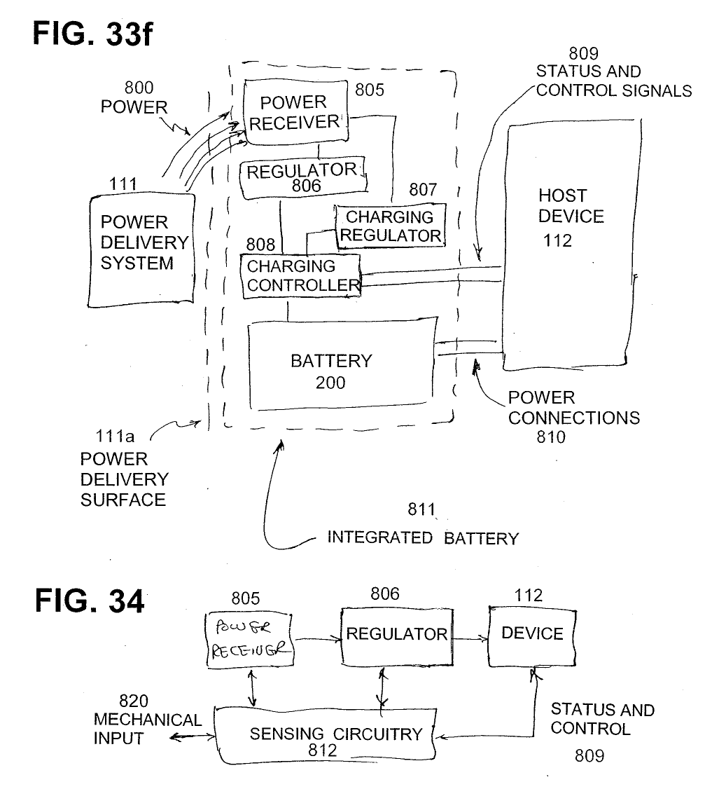

FIG. 33a is a schematic block diagram of a device that has a battery with an integrated power receiver. This is a ‘dumb’ battery 801 that requires the host mobile device 112 to supply the appropriate voltage and/or current limit 806. The host mobile device 112 would require charging circuitry 807 and/or a regulator 806 in order to charge the battery 200. The battery 200 electrically connects 804 to the host device 112 allowing charging and discharging. The power receiver 805 delivers power 800 from the power delivery surface 111a to the host device 112. In this configuration, the operation of the battery 200 and the power receiver 805 are independent. If the output of the power receiver 805 is not compatible with the power requirements of the host device 112, the host device must have a power regulator 806 to condition the characteristics appropriately. In addition, the host 112 must have a charging regulator 807 to appropriately charge the battery 200.

FIGS. 33b and 33c are perspective drawings of a battery 200 and a host device 112. The connections on the battery 200 that mate with the host battery operated device 112 are as required for the host device 112 to use and charge the battery 200. Additionally the battery may include power contacts 205 from the compatible adapter. FIG. 33b shows the physical configuration of the battery 200 with integrated power receiver 805. The output of the power receiver 805 is internally wired to the host electrical connections 804. The host electrical connections 804 mate with the host contacts 205. FIG. 33c shows a typical host device 112 with a battery compartment 204. Host contacts 205 mate with the host electrical connections 804. A battery cover 210 may or may not be used depending on the configuration. If a cover 210 is used, it must have appropriate mechanical allowances 120 for the power receiver 805 integrated into the battery 200.

FIG. 33d is a schematic block diagram of a device that has a battery with an integrated power receiver 805 and regulator 806. The connections on the battery 804 that mate with the host mobile device 112 are as required for the host device 112 to use and charge the battery 200. Additionally, the battery 200 may include power contacts from the compatible adapter and power contacts from a regulated version of the adapter power. The host mobile device 112 would require charging circuitry 807 in order to charge the battery. The physical configuration would be identical to that shown in FIGS. 33b and 33c. However, in this case, the integrated battery 802 houses the regulator 806, so that the host device 112 does not need to. However, the host 112 must have a charging regulator 807 to appropriately charge the battery 200.

FIG. 33e is a schematic block diagram of a device that has a battery 200 with an integrated power receiver 805, regulator 806, and charging regulator 807. The integrated converter 807 provides the appropriate voltage and/or current for proper operation of the charging controller within the mobile device. This is a universal pad-enabled battery 803 that provides the mobile device 112 with all the necessary voltages/currents for charging. This battery requires a host mobile device 112 to control the charging. If the battery 200 were set on the pad 111a by itself, it would not be able to self charge. The host device 112 has electrical connections 804 to the various integrated systems. The host device does not contain the regulator 806 or the charging regulator 807. The physical configuration is similar to FIG. 33b.

FIG. 33f is a schematic block diagram of a device 112 that has a fully integrated battery 811. The fully integrated battery 811 is integrated with a compatible adapter, and contains a complete charging and monitoring circuit 808. The battery 811 will provide connections 810 to the mobile device that include monitoring signals 809 such that the mobile device can determine, for example, the state of charge. This is a universal pad-enabled battery that takes care of itself (re-charging) and merely supplies the host mobile device 112 with status about itself. Batteries 811 like this may be placed on the pad 111a without the mobile device 112 to be recharged. The fully integrated battery 811 includes an integrated power receiver 805, regulator 806, charging regulator 807, and charging controller 808. The host device 112 receives power 800 from the battery 200, and status and control signals 809 connect the host device 112 to the charging controller 808. The status and control signals 809 connecting the battery 811 to the host may include signals indicating that the battery is charging, that the power receiver is receiving power, the battery voltage, etc. The fully integrated battery 811 has the ability to be recharged on the power delivery surface 111a without being installed in the host 112.

FIG. 34 is a block diagram of a device 112 equipped with a power receiver 805, optional regulator 806, and sensing circuitry 812. This system for mobile devices can detect and report certain statuses 809 to the on-board intelligence of the device 112. The device 112 may be able to distinguish between such things as: 1) pad enabled and working properly, 2) pad shut down due to a low value of resistance detected across the pad potential, 3) pad shut down due to no valid load connected across the pad. The device adapter 812 can report certain statuses 809 to its host depending on the details of implementation of the safety techniques used on the power delivery surface. Since the details and capabilities of the sensing circuitry 812 depend on the details of the fault protection scheme used by the power delivery surface, the following examples in FIGS. 34-37 are not intended to disclose all embodiments. Instead the examples show generally the types of capabilities and types of techniques used to attain status of the power delivery surface. A person skilled in the art may apply these principles to other fault schemes resulting in different implementations that are among the various embodiments conceived.

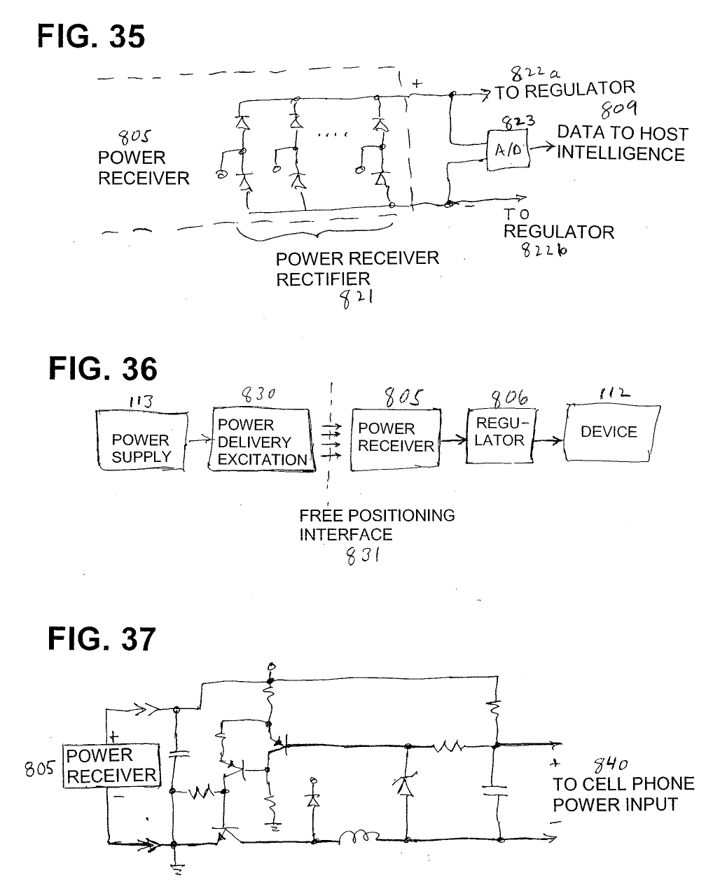

FIG. 35 is a schematic diagram of a circuit to sense the shut down of the power delivery surface. The power receiver 805 and/or regulator 806 of an electrical device 112 may be monitored to determine the status of the power delivery surface. For example, if the power delivery surface shuts down due to an over-voltage condition, the voltage on the surface will be greater than a threshold, and not within a range centered around the nominal operating voltage. This condition can be sensed via a number of methods obvious to those skilled in the art, for example by using an analog to digital converter 823 to monitor the rectified output 821, 822a, 822b of the power receiver 805. Another example is that the mobile device 112 can determine if it is alone on the power delivery surface when in standby. In this case, the mobile device 112 can sense the presence of excitation on the power delivery surface. If the mobile device itself is drawing power less than the minimum power threshold of the power delivery surface, and this condition persists for a time greater than the minimum power timeout, then the device can reasonably conclude that it is sharing the power delivery surface with another load. A short or no excitation from the power delivery surface can be detected and distinguished from a power delivery surface in sleep mode. This can be implemented as shown in FIG. 35. In this case the host mobile device commands the analog to digital converter 823 to measure the power receiver rectifier 821 output 822a, 822b. If the value is consistent with the voltage used for sleep mode, then the host mobile device intelligence can assume there is a short or no excitation from the power delivery surface. If the measured output 822a, 822b of the power receiver rectifier 821 is zero (or close to it), then the host mobile device can conclude that either the host mobile device is not in proximity to the power delivery surface, or the power delivery surface is shut down or shorted. A mechanical switch 820 can add further information for deducing the status. An optical sensor may also be used to determine further information about the surface upon which the device is resting, or whether it is resting on a surface at all. Other such status conditions can be detected in a similar manner.

FIG. 36 is a block diagram of universal device interface formed by integrating a power converter (regulator) 806 between the power receiver 805 and the device's 112 power input. Devices of varying power requirements may be powered from power delivery surfaces (pads) of a fixed and predetermined voltage. Certain devices 112 may already be compatible with the voltage supplied by the pad and need no special consideration. Certain other devices may require a mechanism such as a regulator 806 to convert the pad voltage to a voltage suitable for use by the specific device. For such devices, a converter 806 can be integrated within the system, thereby providing for such devices to be compatible with the pad voltage. A universal device interface may be formed using a fixed excitation by integrating a power converter (regulator) 806 between the power receiver 805 and the device's 112 power input. A power supply 113 delivers power to a power delivery exciter 830. The power delivery exciter 830 creates the necessary power format required by or to form the power delivery surface. Power is delivered through a free positioning interface 831 and received by a power receiver 805. The power receiver 805 output may be suitable or may not be suitable for application directly to the device 112, depending on the power receiver 805 output, and the device's 112 input power requirements. A regulator 806 converts the power receiver 805 output to the characteristics required at the device input 112. In this way, devices of varying input requirements may be operated from a standardized power delivery surface. In this case it would not be necessary for the power delivery surface to adjust itself to suit a particular device's input requirements.

FIG. 37 is a schematic diagram of the regulator circuit between the power receiver 805 and the device's power input 840. The switching regulator of FIG. 37 converts a high voltage output from a power receiver to a constant current source output typically used for a cell phone input 840. This regulator delivers 7.5V max and 350 mA max to the cell phone input 840, in accordance with manufacturers requirements. Other types of regulators are known to those skilled in the art. Some high power devices do not require a regulator since their power requirements are already compatible with the output of the power receiver. A wire-free power delivery system may be made more universal by selecting a predetermined excitation and other system characteristics appropriately. The idea would be to choose these parameters such that the highest power devices that may use the system as a power source do not need a power regulator. In this way, the most costly and/or impractical regulators are not needed to attain the most universal application of the power delivery system.

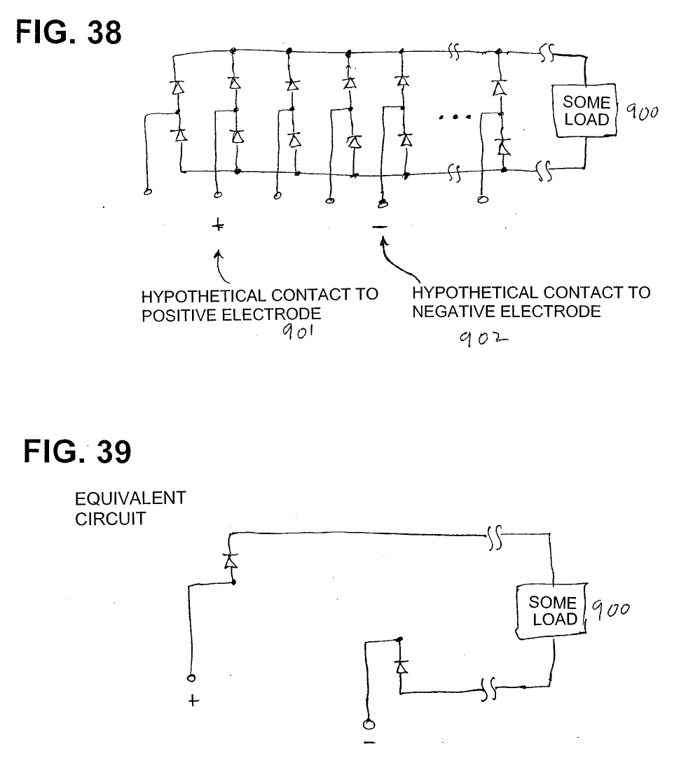

FIG. 38 is a schematic diagram of a bridge rectifier circuit used to detect a linear load. The difference between a linear load receiving power from the power delivery surface (such as a set of keys or a sweaty arm), and non-linear characteristics of a power receiver or power-receiver-enabled device may be tested and detected. For the purposes in this context, a linear load is defined as having properties similar to that of a resistor. If a linear load of an equivalent resistance less than a critical value is detected during the test, the power supply removes full drive to the power delivery surface. The power supply may periodically perform the test and, when a resistive load is no longer present, apply full drive to the power delivery surface. Alternatively, after such detection and subsequent removal of full drive, the power supply may require an external input to restore full drive to the power delivery surface. In one embodiment, the power delivery surface is energized with an AC potential and a triac trigger circuit tests for an equivalent resistive load during the AC voltage zero-crossings. In another embodiment, the power delivery surface is energized with a DC power that is repetitively interrupted with a low voltage test signal at a low duty cycle to periodically test for an equivalent resistive load. In another embodiment, a low amplitude drive is applied to the power delivery surface. The power draw at low power is compared to the power draw at high power and it is determined whether the load is sufficiently non-linear to continue. Sensing of a linear load is accomplished by exploiting the voltage drop necessary to turn on a diode. Since a compatible load consists of a set of contacts and a bridge rectifier as shown in FIG. 38, all legitimate compatible loads will appear as some type of load 900 connected to two series diodes 901, 902.

FIG. 39 is a schematic diagram of the equivalent load 900 connected to the circuit of FIG. 38.

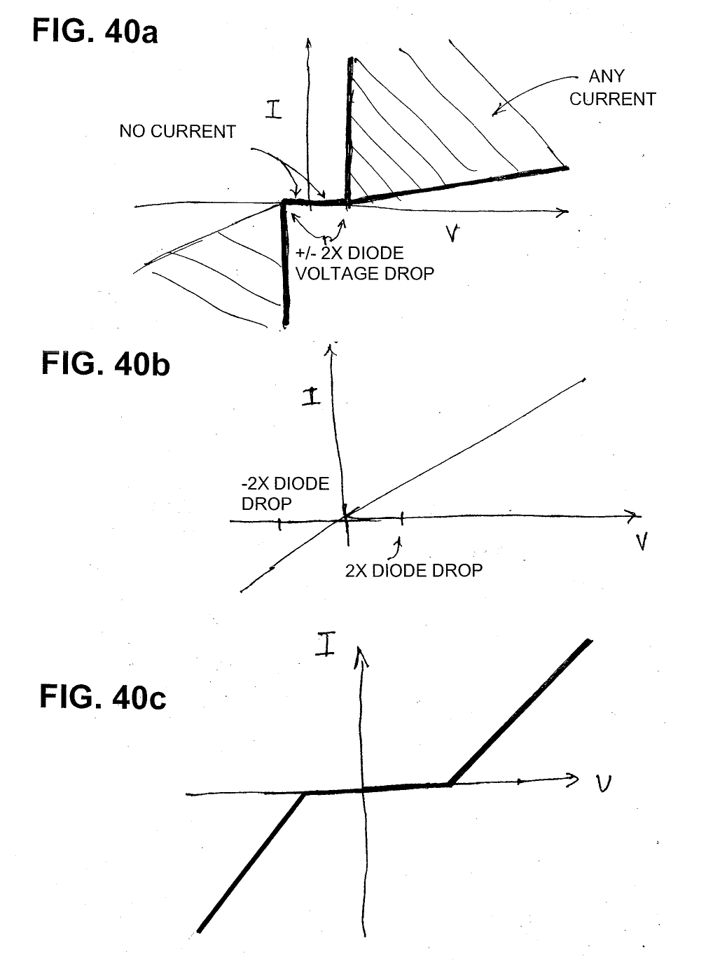

FIGS. 40a, 40b, and 40c are Voltage/Current (V/I) characteristic graphs for the circuit of FIG. 38 under various conditions. FIG. 40a shows the V/I characteristic graph for applied voltages less than 2 diode drops (1.2V for standard rectifiers, 0.8V for schottky rectifiers). There are no current flows. Above voltages of 2 diode drops, current can flow. The amount of current that can flow above this threshold is dependent on the type of load the adapter is powering. FIG. 40b shows the V/I characteristics of a resistive load. An inductive load or a capacitive load is similar in that some current may flow at applied voltages less than 2 diode drops. Other systems, for example inductive solutions, may also sense the proper loads with the same technique. FIG. 40c shows the V/I characteristics of a resistive load driven through diodes. The difference between the V/I characteristics of a linear load, and a load that is connected to the system through diodes can be distinguished. This is also true of other forms of power transfer including induction. In the case of induction, there is a ‘primary’ and a ‘secondary’. The secondary is connected to a bridge rectifier to produce a DC output voltage to drive a load. The power drawn by the circuit varies with the amplitude of the AC applied to the primary. In this way, the characteristic shown in FIG. 40c can be used to distinguish between a desired load, and an undesired load. To do this, the applied amplitude would be reduced to an amount that would not result in rectifier conduction in the secondary. If significant energy is being dissipated, then it can be deduced that the load is an undesired load, since a rectifier characteristic was not detected. Likewise, if no energy is being dissipated at low applied primary excitation, then it can be assumed that the load is a desired load. To summarize, compatible loads contain diodes and therefore do not conduct until the applied voltage exceeds 2 diode drops. Any load that conducts significant current at applied voltages below 2 diode drops is defined to be an undesired load. The concept is to distinguish a compatible load from an unwanted load by applying a non-zero voltage lower than 2 diode drops and measuring the current drawn. If there is significant current, it is determined that an undesired load is present. The techniques involve applying working voltage to the pad, but occasionally reducing the voltage to near zero to test of an undesired load. Two methods are but discussed, but there are many other methods available.

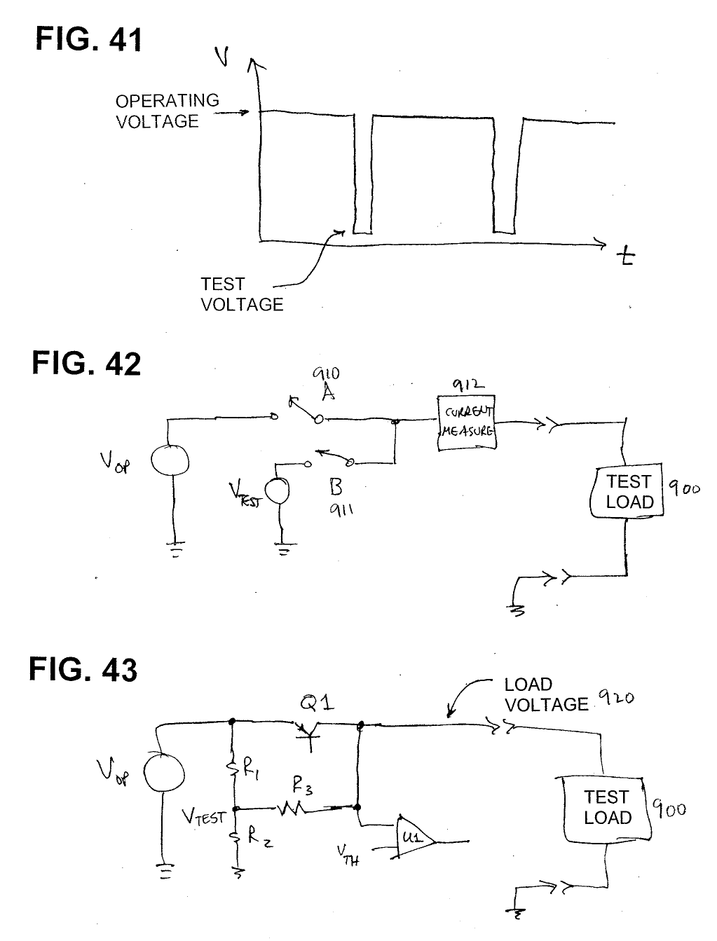

FIG. 41 is a voltage versus time graph when applying switched DC to the circuit of FIG. 38.

FIG. 42 is a conceptual circuit of the switched DC application of FIG. 41. For a time, switch A 910 is closed, while switch B 911 is open, allowing operational voltage to be applied to the pad. Sometimes, switch A 910 opens, and switch B 911 closes, and the current drawn 912 is measured. If significant current flows, then it is determined that an undesired load 900 exists. The system may respond in various ways to the detection of an undesired load 900. For example, switch A 910 could remain open, and switch B 911 could remain closed until such time as the measured current 912 falls below an acceptable level.

FIG. 43 is a desired circuit for responding to the switched DC application of FIG. 41. In this case, R1 and R2 form a voltage divider dividing the Vₒₚ voltage to a value less than 2 diode drops. R3 becomes the current sensing resistor and U1 detects the condition. When Q1 is on, Vₒₚ is applied to the test load 900 (or simply, the load). Occasionally Q1 will turn off to allow the test for undesired loads to be performed. When Q1 turns off, Vₒₚ is applied to the load through R3. If the load draws no current, then the load voltage 920 will be equal to Vₜₑₛₜ. If significant current is drawn by the load 900, the current through R3 will cause the load voltage to drop below Vₜₑₛₜ. The comparator U1 detects the presence of an undesired load 900 by comparing the load voltage 920 to Vₜₕ. If the load voltage 920 is below Vₜₕ during the test, then it is determined that an undesired load 900 is present. One possible response the system could provide is to inhibit further action of Q1 until the load voltage 920 exceeds Vₜₕ. This is equivalent to saying that the Vₒₚ will not be further applied until the undesired load 900 is removed.

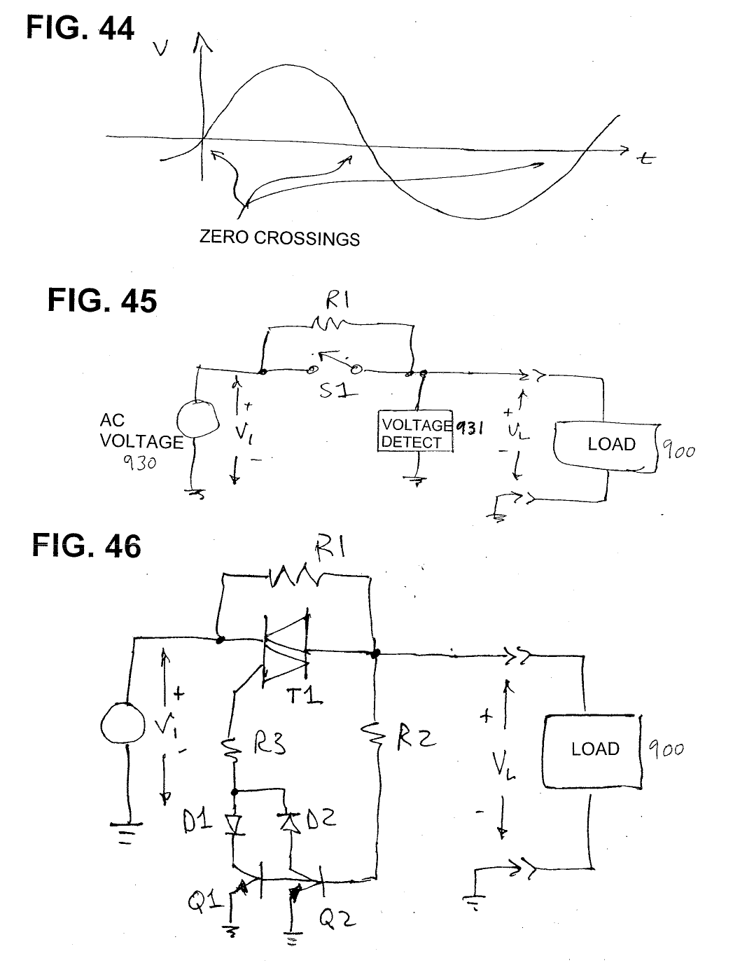

FIG. 44 is a plot of the voltage versus time graph to locate zero crossings when an AC current is applied. This is a graph of another embodiment that uses AC excitation and exploits the zero crossings that occur twice on each cycle. Near the zero crossings, the voltage is low enough to perform the test described above.

FIG. 45 is block diagram of a circuit consistent with the graph of FIG. 44. S1 is commanded to turn off when the AC voltage 930 instantaneously nears zero. When the absolute value of V1 is low, the switch S1 is turned off. When S1 is off, then V1 is applied to the load 900 through resistor R1. As the absolute value of V1 moves below 2 diode drops, the current drawn by the load 900 may be detected by measuring the drop across R1. If there is no drop, then no current is being drawn. If there is significant current, there will be a measurable drop across R1. In this case, an undesired load 900 is present, and the switch S1 can be left open until the undesired load 900 is removed.

FIG. 46 is circuit schematic of a circuit consistent with the block diagram of FIG. 45. In this circuit, the triac T1 is retriggered on each half cycle of the applied AC voltage V1. Triac T1 turns off when the current passes through zero. As the voltage continues through zero and increases in absolute value, a drop may appear across R1 through a current due to the load 900. If that current is too great, the voltage V1 will not grow large enough to turn on Q1 or Q2, and so, therefore, T1 will not trigger and V1 will remain low. If no undesired load 900 is connected, then the voltage will grow sufficiently to turn on Q1 or Q2. In that case the triac T1 will be triggered through R3 and D1 or D2, and full voltage V1 will be applied to the load 900.

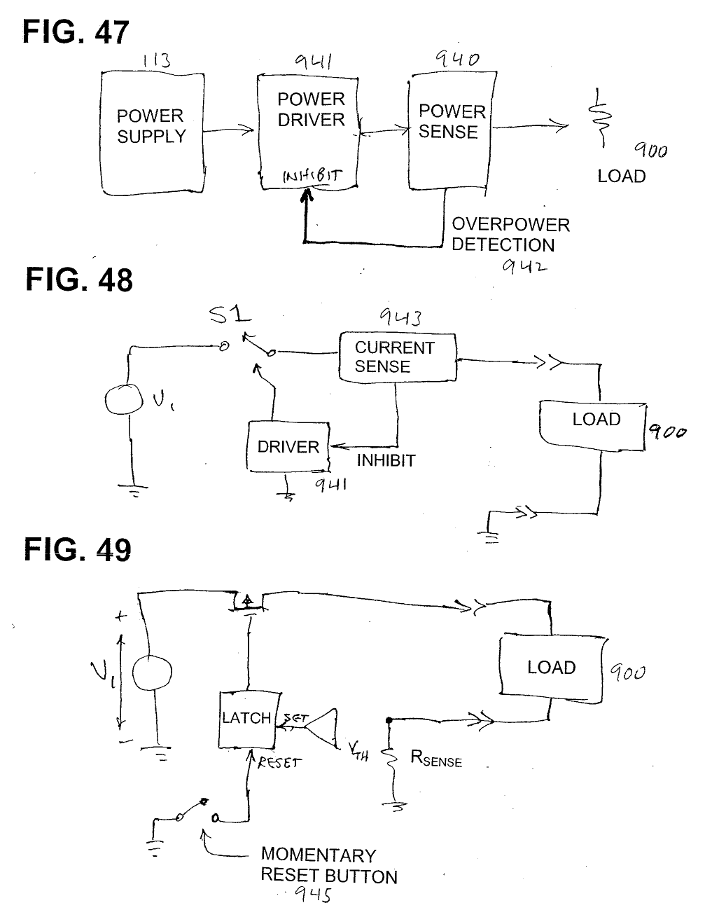

FIG. 47 is a block diagram of an overpower detection and shutdown system. The power delivery surface shuts down immediately upon detection of a power draw in excess of a predefined threshold power. Full drive to the power delivery surface can be restored by a reset button or other external stimulus. If the excess power draw condition still exists upon restoring operation, it will be detected and the power supply apparatus will again instantly shut down and the cycle will repeat. In one embodiment, the power can be measured by monitoring the current flow to the power delivery surface. Over power detection can be used to detect undesired loads 900 such as a short circuit. When a power sensor 940 detects that the delivered power is too great, it inhibits the power driver 941. In this figure, the power supply block 113 represents a source of useable power. The power driver 941 conditions and/or switches the power as required by the method of power transfer used. The power sense block 940 provides a response when the output power as delivered by the power driver 941 exceeds a limit. The power driver 941 has a mechanism that allows it to be disabled (inhibited) by a signal 942 from the power sense block 940. When an overpower condition occurs, the response could be to indefinitely shut down the power driver 941. Normal operation may be resumed by the appropriate external stimulus.

FIG. 48 is a circuit block diagram of an electronic switch for a conductive solution to the overpower detection and shutdown system. For a conductive solution, the power driver 941 may consist of an electronic switch S1 to connect the power supply to the power transfer surface for conduction into a load 900. In a conductive device it is often convenient to measure the delivered power by measuring the output current 943. In a conductive solution, delivered power is proportional to output current given that the voltage remains fixed.

FIG. 49 is a circuit schematic of an embodiment of the block diagram of FIG. 48. When too great a current flows through the load 900, the voltage drop across Rₛₑₙₛₑ exceeds Vₜₕ, and triggers the system to shut down. In this embodiment the shutdown condition will persist until the reset button 945 is pushed.

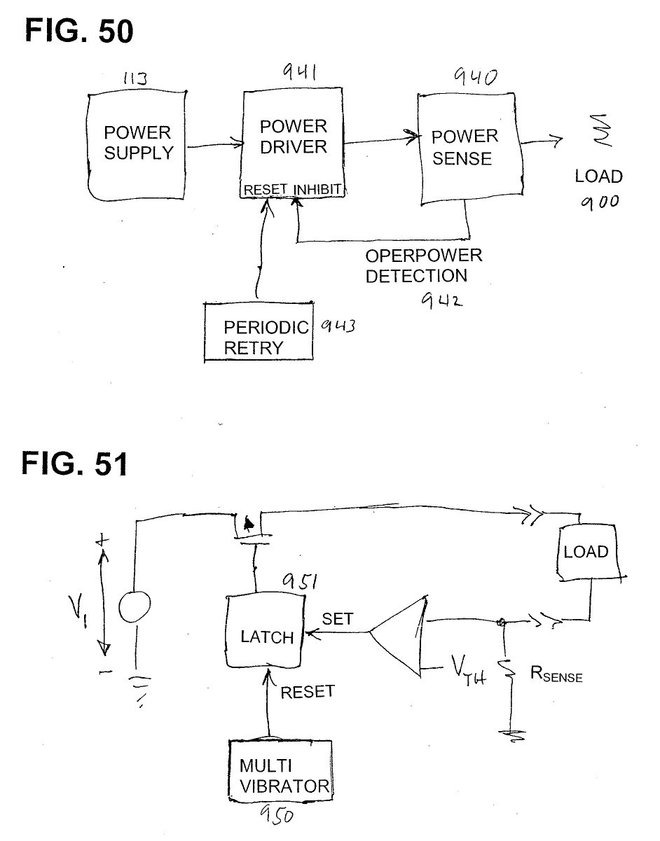

FIG. 50 is block diagram of an overpower detection and shutdown system with automatic retry. The power delivery surface shuts down shuts down immediately upon detection of a power draw in excess of a predefined threshold power. After detection of the excess power draw, the power supply apparatus 113 waits a predetermined amount of time and then restores power to the power delivery surface. At such time, if the excess power draw condition still exists, it will be detected and the power supply apparatus 113 will again instantly shut down and the cycle will repeat. In one embodiment, the power can be measured by monitoring the current flow to the power delivery surface. Thus, the system adds the ability to attempt to start up periodically, rather than waiting for an external stimulus. FIG. 50 shows a block diagram of a power transfer system in which a timer 943 initiates a periodic retry by sending a reset signal to the power driver. In this case, an overpower condition would shut down the output and then periodically the output would be turned on again. If the fault condition still exists, the process would repeat.

FIG. 51 is circuit block diagram of an embodiment of the block diagram of FIG. 50 for a direct conduction system. In the embodiment shown for a direct conduction system a multi-vibrator 950 periodically causes a reset signal to be sent to the latch 951. In this case, an overpower condition would shut down the output and at some later time, the multi-vibrator 950 would reset the latch 951, thereby affecting a retry.

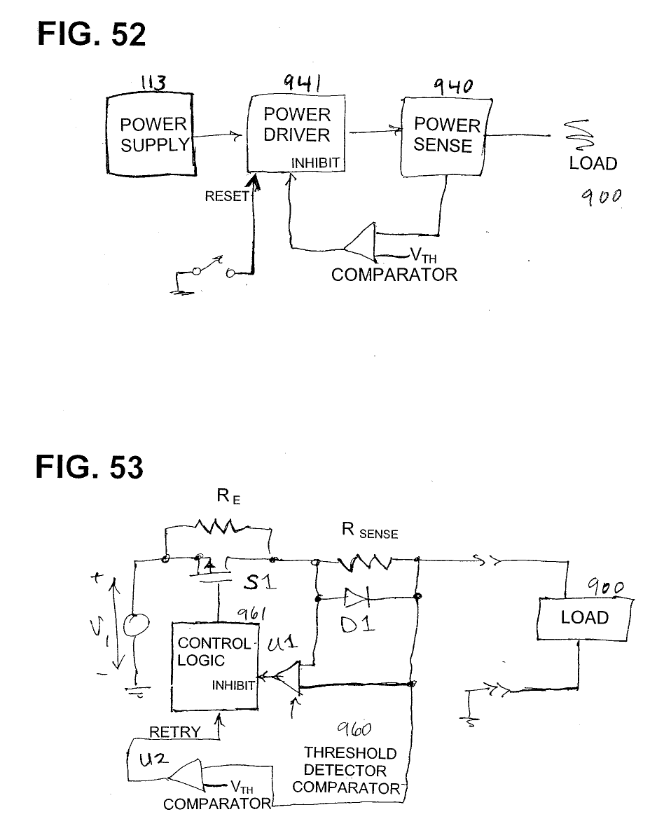

FIG. 52 is a block diagram of an under power detection and shutdown system. The power delivery surface will not apply the full drive to the power delivery surface unless a power receiver is present that draws a minimum, predefined amount of power. A partial potential is applied to the power delivery surface to detect the presence of a power receiver that draws power in excess of the threshold value. As a result, the power delivery surface will be only partially energized unless at least one power receiver is drawing the minimum power from the power delivery surface. In one embodiment, the power receiver may employ a dedicated load 900 to consume a power above the threshold to insure that the power delivery surface becomes fully energized when the power receiver is present. In another embodiment, a power-receiver-enabled device may control the load 900 presented to the power receiver to possibly control the energization of the power delivery surface. The power transfer device can shut down when it is not being called upon to provide power above a minimum threshold. When the power delivered as sensed 940 by the circuit falls below a threshold, the power driver is inhibited. Another term for this may be “sleep mode”. Manual or periodic reset signals, or some other type of load detection device may be used to automatically restart the power driver.

FIG. 53 is a circuit schematic of an embodiment of the block diagram of FIG. 52. FIG. 53 shows an embodiment for a conduction-based system. In this case, current is used to deduce the power drawn by the load 900. Current to the load 900 is measured by resistor Rₛₑₙₛₑ. Diode D1 prevents the voltage drop across Rₛₑₙₛₑ from being larger than a diode drop when high powers are being drawn. A threshold detector/comparator 960 gives a response when the drop across Rₛₑₙₛₑ exceeds a predetermined value. At such time, the control logic 961 disables further power from being delivered to the load 900. This condition persists until a manual reset or other external stimuli (not shown), or until a load 900 is detected as present. Detecting for a load being present is accomplished through energizing resistor Re. Resistor Re supplies a very small amount of test current. If a load 900 is present, the drop across Re will be sufficient to trigger the comparator U2. In such a case, the control logic 961 begins driving the switch S1 to provide power to the load 900 that is present.

FIG. 54 is a circuit diagram of an over voltage detection system. In a conductive solution, it is possible that a load 900 might be present that is applying a voltage to the power delivery surface. Such a load may trick the linear load detector or other protection schemes resulting in full power being inappropriately or unsafely delivered to the undesired load 900. FIG. 54 shows a method of protecting a direct contact power delivery scheme from the possibility that an active load 900 is present. The driver block 941 periodically turns off switch S1. When switch S1 is off, the load voltage should drop to zero. However, if an active load 900 is present or a energy storage device such as an inductor or capacitor is present, then the voltage measured by the comparator 965 may exceed a predetermined threshold Vₜₕ. If so, further drive to switch S1 by the driver block 941 would be disabled until such time as the potential across the load 900 falls below the predetermined value set by Vₜₕ.

FIG. 55 is a circuit diagram of a desired load detection system. For conductive-based power delivery, the presence of a desired load can be detected without the need to apply full power. Periodically the driver 941 opens switch S1. When switch S1 is open, the voltage on the load 900 will be driven by Vₜₑₛₜ through Rs. The value of Vₜₑₛₜ is chosen to be above 2 diode drops, so that if a desired load 900 is present, current may flow through Rs. The comparator 965 tests the load voltage against a threshold Vₜₕ to determine if a desired load pulled Rs down or not.

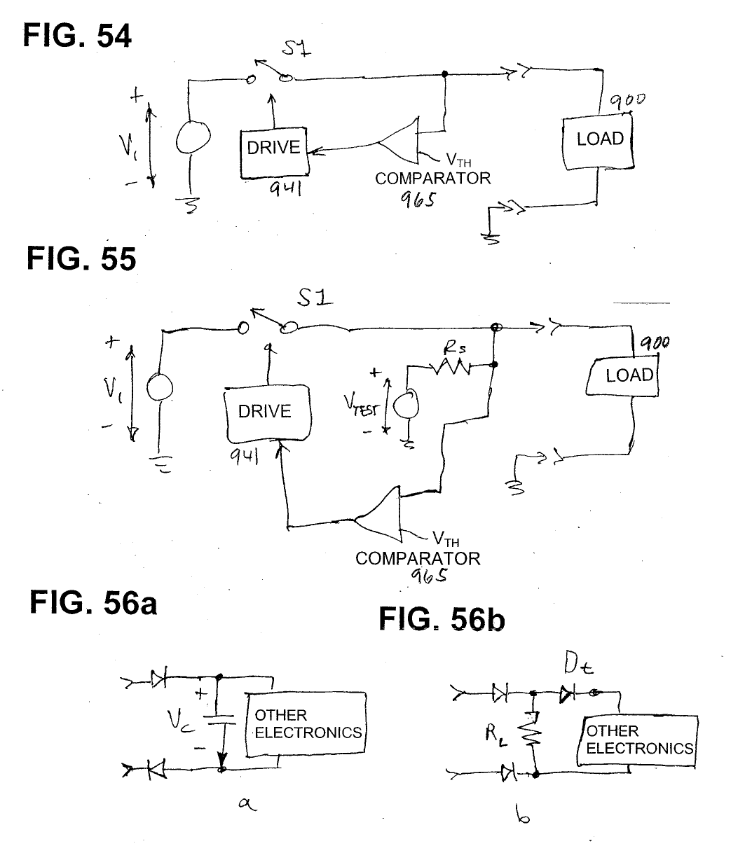

FIGS. 56a and 56b are circuit diagrams for certain desired loads. This method disclosed with respect to FIG. 55 does not always accurately detect the presence of a load. In certain cases, even a desired load may not pull down the voltage at resistor Rs. FIG. 56a shows a desired load with a capacitor. Provided the capacitor got charged when switch S1 was on, it may not get sufficiently discharged after switch S1 is opened in time for the comparator output to be correctly interpreted. If Vc is much greater than 2 diode drops, the diodes will not conduct, and the comparator will indicate that no load is present. A resistor R1 and diode Dt can be added to the load as shown in FIG. 56B to insure the test accurately reflects the presence of the load. Another mode of operation is to use the minimum current detector to indicate the presence of a load. However, this scheme of load detection can still be valuable for the purpose of waking the system out of a sleep mode. If the system were put into sleep mode, say by virtue of the minimum current detector showing that no load was present, then the power delivery surface can apply a ‘sleep’ voltage, Vₜₑₛₜ, indefinitely while the comparator constantly checks for the presence of a load. When a load comes in contact with the power delivery surface, the comparator will indicate a load is present (as long as the voltage Vc shown in FIG. 56a eventually discharges to zero, or the load is configured as in FIG. 56b).

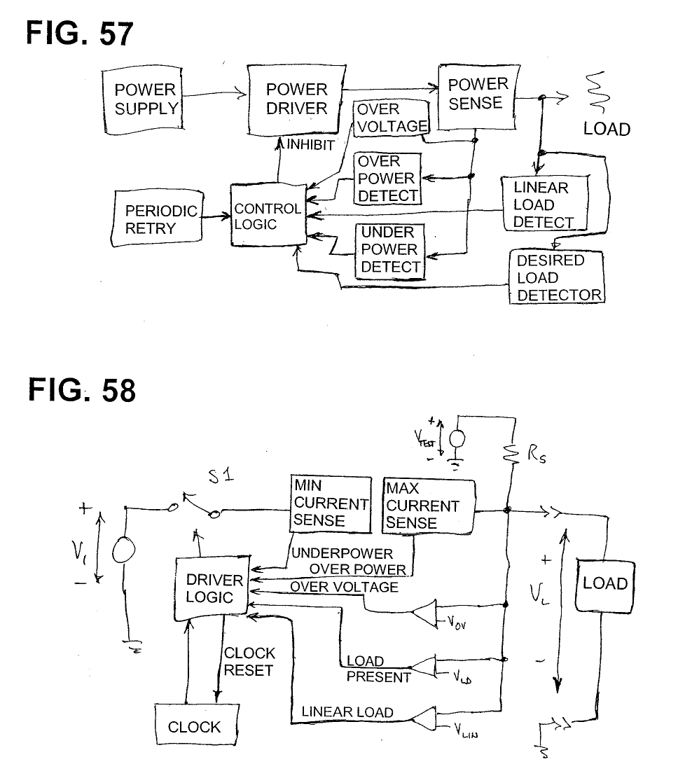

FIG. 57 is a circuit block diagram for a combination detection and shutdown with automatic retry system. An embodiment includes a combination of detection criteria tested at an appropriate period where applicable. When shutdown, appropriate periodic reset testing is employed. Combinations of the above safety shutdown methods provide improved safety over any single technique described above. FIG. 57 illustrates a system with all of the aforementioned safety protection inventions applied. In this case, drive to the power delivery surface will be shut down if: a) the load draws too much power; b) the load draws too little power, or is not present; c) the load is linear, and is therefore assumed to be undesired; or d) if the power delivery method is direct conduction, then an overvoltage condition will also cause the power delivery surface to shut down. If the device determines that there is no load present, it may go into a sleep mode. Wake up is determined by the above load detector circuit using a small applied voltage Vₜₕ. Periodically, the system resets itself while in a fault condition to determine if the fault persists. Note that periodic retry can be triggered by a time delay, or by one or more fault conditions resolving. Control logic determines whether sufficient fault conditions have resolved to justify an attempt at applying more power. For example, a shorted load can be detected without the need to apply full power. In that case, full power turn-on will not be attempted until the short condition goes away.

FIG. 58 is circuit diagram for another embodiment of a combination detection and shutdown with automatic retry system. When multiple detection schemes are combined, the specific circuit configuration may take advantage of common elements used for the various techniques. A scheme is shown for a direct conduction power delivery surface in FIG. 58. In this case, the drive logic occasionally directs switch S1 to open momentarily. The timing for this is determined by the clock. When switch S1 opens, several tests are made simultaneously based on the voltage V1. These are: a) the over voltage test, b) the load present test, and c) the linear load test. The maximum current test block determines the overpower condition. The minimum current sense determines the no-load (under power) condition. It is wise to require a minimum amount of time to pass before an under power condition is validated. This prevents the device from entering sleep mode if there is a momentary under power condition. When in sleep mode, the device can wake up only if a linear load condition is not detected, a load is detected, and an over voltage condition does not exist.

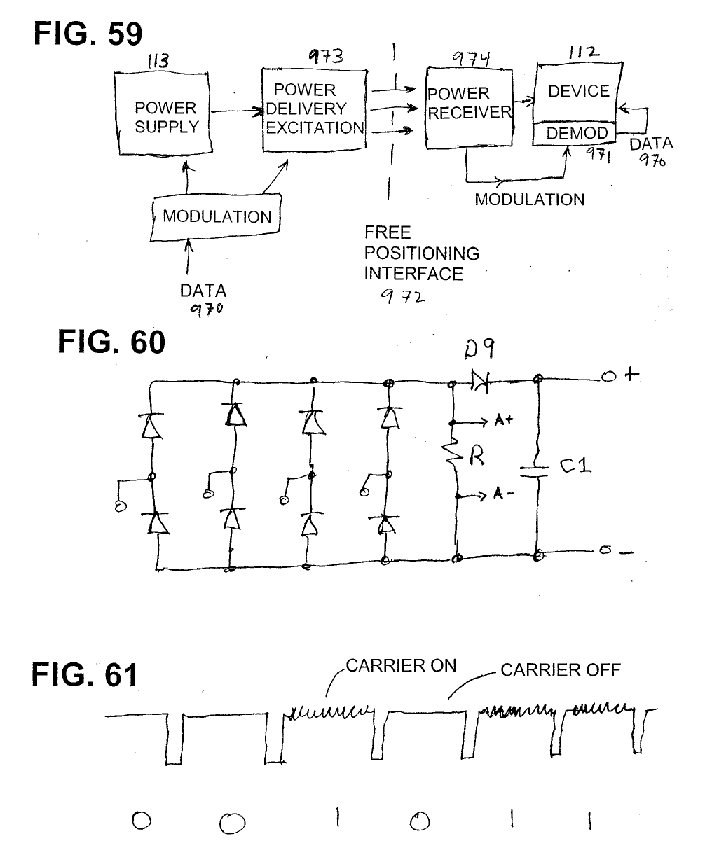

FIG. 59 is a block diagram of a system for the power delivery surface (pad) to send data 970 to an electronic device 112. The data 970 may be transmitted from the pad to the devices 112 by using power supply modulation. A power delivery surface can transmit data 970 to power receivers using amplitude or frequency modulation. FIG. 59 shows a block diagram of the technique where data 970 is modulated on the driver side of the free positioning interface 972. On the electronic device side of the free positioning interface 972, the modulation is detected and demodulated. The modulation may be further modulated (modulation on top of modulation) using any number of schemes apparent to those skilled in the art. In one embodiment related to a conductive power delivery surface, the power supply voltage can be modulated, and then subsequently detected at the power receiver. Such a power receiver detector is shown in FIG. 60.

FIG. 60 is a circuit diagram of a power receiver detector circuit. Here, diode D9 is used to charge capacitor C1 with the peak voltage output of the power receiver rectifiers. However, an amplitude modulated signal can be detected across resistor R. There are many possible schemes of modulating and modulating carriers given this basic method of detection. In one embodiment, a bit period is defined by the safety testing interval as described in the safety protection discussion above. A typical safety test rate might be 400 Hz. A detector could easily detect the safety testing interval.

FIG. 61 is a diagram of the data transfer described in FIG. 59. Within each interval, on/off keying of a carrier amplitude modulated onto the power supply voltage can be used to send data. In the case of inductive or capacitive coupling, the driver frequency could be frequency modulated to transmit the data.

Since these and numerous other modifications and combinations of the above-described method and embodiments will readily occur to those skilled in the art, it is not desired to limit the invention to any of the exact construction and process shown and described above. While a number of example aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope. The words “comprise,” “comprises,” “comprising “has,” “have,” “having,” “include,” including,” and “includes” when used in this specification and in the following claims are intended to specify the presence of stated features or steps, but they do not preclude the presence or addition of one or more other features, steps, or groups thereof.

What is claimed is:

1. An electrical apparatus, comprising:
a power delivery surface that comprises at least a part of a support surface, said power delivery surface being connected to an electrical power source, said power delivery surface being capable of supplying electrical power; and
an electrical device, which is supplied electricity and is positionable in any location on a support surface, said electrical device obtaining electrical power from said power delivery surface that is at least part of said support surface.

2. The electrical apparatus of claim 1 wherein said power delivery surface supplies electricity to said electrical device via an electricity supply technique, said electricity supply technique being comprised of at least one of the group consisting of: conduction, induction, capacitive, acoustic, optical, and microwave.

3. The electrical apparatus of claim 1 wherein said electrical power source is comprised of at least one of the group consisting of: electrical outlet, battery, vehicle cigarette lighter system, solar power system, and direct connection to electrical generator device.

4. The electrical apparatus of claim 1 further comprising:
a magnetic field electrical circuit that causes a magnetic field to change, said magnetic field electrical circuit being a part of said power delivery surface; and
an inductive element that induces an electrical current when exposed to a changing magnetic field to supply said electrical device with electricity, said inductive element being a part of said electrical device.

5. The electrical apparatus of claim 1 further comprising a plurality of electrical devices that are supplied electricity and are positionable at any location on said support surface, said plurality of electrical devices obtaining electrical power from said power delivery surface that is at least part of said support surface.

6. The electrical apparatus of claim 1 wherein said electrical device is powered by electrical power supplied by said power delivery surface.

7. The electrical apparatus of claim 1 wherein said electrical device is charged by electrical power supplied by said power delivery surface.

8. The electrical apparatus of claim 7 wherein said electrical device comprises a battery system, said battery system charging without being incorporated into a host device.

9. The electrical apparatus of claim 8 wherein said battery system further comprises:
a battery that stores electrical energy, said battery charged by said power delivery surface;
a power receiver circuit integrated with said battery that delivers electrical power from said power delivery surface to said battery;
a regulator circuit integrated with said battery that conditions voltage deliver by said power delivery surface to match a desired voltage of said battery; and
a charging controller circuit integrated with said battery that manages the charging of the battery to ensure proper charging of said battery.

10. The electrical apparatus of claim 7 wherein said electrical device comprises a battery system, said battery system being further incorporated into a host device to achieve charging of said battery system.

11. The electrical apparatus of claim 10 wherein said battery system further comprises:
a battery that stores electrical energy, said battery charged by said power delivery surface; and
a power receiver circuit integrated with said battery that delivers electrical power from said power delivery surface to said battery, wherein said host device incorporating said battery system includes a regulator circuit that conditions voltage delivered by said power delivery surface to match a desired voltage of said battery, and said host device further includes a charging controller circuit that manages the charging of the battery to ensure proper charging of said battery.

12. The electrical apparatus of claim 10 wherein said battery system further comprises:
a battery that stores electrical energy, said battery charged by said power delivery surface; and
a power receiver circuit integrated with said battery that delivers electrical power from said power delivery surface to said battery; and
a regulator circuit integrated with said battery that conditions voltage deliver by said power delivery surface to match a desired voltage of said battery, wherein said host device incorporating said battery system includes a charging controller circuit that manages the charging of the battery to ensure proper charging of said battery.

13. The electrical apparatus of claim 1 wherein said electrical device is comprised of at least one of the group consisting of: toy, game device, cell phone, battery, charger, handheld device, power tool, power connector, cup, music player, camera, calculator, remote control, video cassette recorder (VCR), digital video disc (DVD), fax machine, computer, personal digital assistant, grooming devices, electric shaver, electric toothbrush, hair clippers, appliance, television, and refrigerator.

14. The electrical apparatus of claim 1 wherein said electrical device further comprises:
a power receiver system that receives electrical power from said power delivery surface; and
a host device that utilizes said electrical power received from said power deliver surface.

15. The electrical apparatus of claim 14 wherein said power receiver system is incorporated into said host device.

16. The electrical apparatus of claim 14 wherein said power receiver system is connected to said host device through a power connector system.

17. The electrical apparatus of claim 16 wherein said power connector system includes a battery system.

18. The electrical apparatus of claim 1 wherein said electrical device further comprises:
a cup that holds liquids;
a heating element powered by electricity that heats said cup and contents of said cup; and
a power receiver system that receives electrical power from said power delivery surface.

19. The electrical apparatus of claim 1 further comprising:
ferromagnetic material incorporated into said support surface such that a magnet will attach to said support structure and receiving power from said power delivery surface that is at least part of said support surface; and
a magnet incorporated into said electrical device such that said electrical device will remain attached to said support structure when said support structure is in a non-horizontal position.

20. The electrical apparatus of claim 1 wherein said support surface is incorporated into a host structure.

21. The electrical apparatus of claim 20 wherein said host structure is comprised of at least one of the group consisting of: vehicle, vehicle dashboard, vehicle center console, vehicle seat, vehicle tray table, vehicle truck bed toolbox, appliance, alarm clock, microwave, refrigerator, furniture, couch, table, desk, electronic device, scanner, printer, laptop computer, building, and fixture.

22. The electrical apparatus of claim 20 wherein said host structure further comprises a tray structure that incorporates said power delivery surface and slides into and out of said host structure.

23. The electrical apparatus of claim 20 wherein said host structure further comprises a tray structure that incorporates said power delivery surface and connects to host structure via a power connector system.

24. The electrical apparatus of claim 1 wherein said power delivery surface may be interconnected with other power delivery surfaces to create a larger power delivery surface.

25. The electrical apparatus of claim 1 wherein said power delivery surface is foldable.

26. The electrical apparatus of claim 1 wherein said power delivery surface may be rolled into a cylinder for storage.

27. The electrical apparatus of claim 1 wherein said power delivery surface receives power through a power connector coupled to the power delivery surface in the same manner as said electrical device.

28. The electrical apparatus of claim 1 wherein said power delivery surface is illuminated.

29. The electrical apparatus of claim 1 wherein said power delivery surface is separated into sections such that each of said sections provides electrical power with separate and distinct electrical characteristics to match the needs of a variety of electronic devices receiving power from said power delivery surface.

30. The electrical apparatus of claim 1 further comprising load detection and shutdown protection for said power delivery surface.

31. The electrical apparatus of claim 1 said electrical device detects a presence of and a status of said power delivery surface.

32. The electrical apparatus of claim 1 wherein said power delivery surface communicates data to said electrical device.

33. An electronic device, comprising:
a battery; and
a plurality of contacts connected to the battery, the contacts being arranged so that when the battery is carried by a power delivery support structure, at least two contacts in the plurality of contacts have a potential difference between.

34. The device of claim 33, wherein the battery is charged in response to the potential difference.

35. The device of claim 33, wherein the battery includes a battery casing through which the contacts extend.

36. The device of claim 33, wherein the battery carries a power adapter circuit which receives a power delivery signal when the battery is operatively coupled with a power delivery support structure.

37. The device of claim 36, wherein the power adapter circuit adapts the power delivery signal to a desired power signal.

38. The device of claim 36, wherein the contacts are arranged so that the power delivery signal S_{PDS} is provided to the adapter circuit independently of the orientation of the battery relative to the power delivery support structure.

39. The device of claim 37, further including a pair of output contacts connected with the power adapter circuit, the desired power signal being outputted by the output contacts.

40. An electronic system, comprising:
a battery having a plurality of contacts connected thereto, the contacts being arranged so that when the battery is carried by a power delivery support structure, at least two contacts in the plurality of contacts have a potential difference between them which charges the battery; and
a battery charger which includes a housing that defines a battery compartment and carries a pair of charger contacts therein, the battery compartment being sized and shaped to receive the battery.

41. The device of claim 40, wherein the battery includes a battery casing through which the contacts extend.

42. The device of claim 40, wherein the battery carries a power adapter circuit in communication with the contacts, the power adapter circuit receiving a power delivery signal when the battery is operatively coupled with the power delivery support structure.

43. The device of claim 42, wherein the power adapter circuit adapts the power delivery signal to a desired power signal.

44. The device of claim 42, further including a pair of output contacts connected with the power adapter circuit, the desired power signal being outputted by the output contacts.

45. The device of claim 44, wherein the pair of output contacts are connected to corresponding charger contacts when the battery is positioned in the compartment.

46. The device of claim 44, wherein the pair of output contacts and power adapter circuit are positioned on opposed sides of the battery.

47. An electronic system, comprising:
a power delivery support structure having a power delivery surface defined by first and second conductive regions;
a battery which carries a plurality of contacts, wherein the first and second conductive regions and the contacts are arranged so at least one of the contacts engages the first conductive region and at least another of the contact engages the second conductive region in response to the battery being carried by the power delivery support structure; and
a power adapter circuit carried by the battery, the power adapter circuit receiving a potential difference between the first and second conductive regions.

48. The system of claim 47, wherein the dimension of each contact is chosen so it does not connect the first and second conductive regions together.

49. The system of claim 47, wherein the power adapter circuit provides a desired potential difference to charge the battery in response to receiving the potential difference from the first and second conductive regions.

50. The system of claim 49, wherein the potential difference is provided to the contacts independently of the orientation of the electronic device relative to the power delivery surface.

51. The system of claim 49, further including a battery charger having a housing that defines a battery compartment and carries a pair of charger contacts therein.

52. The system of claim 51, wherein the battery charger and battery are connected together through a pair of contacts when the battery is positioned in the battery compartment.
